(19) United States
(12) Patent Application Publication
(10) Pub. No.: US 2012/0299805 A1
(43) Pub. Date: Nov. 29, 2012

(54) PROJECTION DISPLAY APPARATUS

(75) Inventors: Takaaki ABE, Osaka (JP); Sosuke OTANI, Nara (JP); Ken MASHITANI, Osaka (JP)

(73) Assignee: SANYO ELECTRIC., LTD.

(21) Appl. No.: 13/481,498

(22) Filed: May 25, 2012

(30) Foreign Application Priority Data
May 26, 2011 (JP) 2011-118172
Dec. 8, 2011 (JP) 2011-269472
Dec. 8, 2011 (JP) 2011-269476

(51) Int. Cl. G09G 3/36

(52) U.S. Cl. 345/58; 345/87

(57) ABSTRACT

The projection display apparatus comprises: an image control unit configured to control a second viewpoint image of the plurality of viewpoint images to suppress crosstalk of a first viewpoint image. The image control unit controls a suppression amount of crosstalk according to a position on the projection plane.

### CROSS REFERENCE TO RELATED APPLICATIONS

This application is based upon and claims the benefit of priority from prior Japanese Patent Application No. 2011-118172, filed on May 26, 2011; Japanese Patent Application No. 2011-269472, filed on Dec. 8, 2011; and Japanese Patent Application No. 2011-269476, filed on Dec. 8, 2011; the entire contents of which are incorporated herein by reference.

### BACKGROUND OF THE INVENTION

1. Field of the Invention

The present invention relates to a projection display apparatus configured to display a stereoscopic image including a plurality of viewpoint images.

2. Description of the Related Art

In the conventional art, in a stereoscopic image including a plurality of viewpoint images (for example, a left eye viewpoint image and a right eye viewpoint image), the viewpoint images are captured from different viewpoint positions (for example, a left eye viewpoint position and a right eye viewpoint position) (for example, JP-A 2004-228743).

In such a stereoscopic image, since interference (crosstalk) occurs between the viewpoint images (for example, the left eye viewpoint image and the right eye viewpoint image), it is necessary to reduce the crosstalk.

### SUMMARY OF THE INVENTION

A projection display apparatus according to a first feature comprises: a light source, an imager configured to modulate light emitted from the light source, and a projection unit configured to project light modulated by the imager onto a projection plane. The projection display apparatus displays a stereoscopic image including a plurality of viewpoint images. The projection display apparatus comprises: an image control unit configured to control a second viewpoint image of the plurality of viewpoint images to suppress crosstalk of a first viewpoint image. The image control unit controls a suppression amount of crosstalk according to a position on the projection plane.

In the first feature, the imager includes a display element including a plurality of micromirrors.

In the first feature, the image control unit switches a control mode for suppressing crosstalk between a subtraction processing mode and an addition processing mode according to an image input signal constituting the stereoscopic image.

In the first feature, the image control unit subtracts an amount of crosstalk corresponding to the first viewpoint image from an image input signal constituting the second viewpoint image, in the subtraction processing mode.

In the first feature, the image control unit adds an amount of inverted crosstalk corresponding to an inverted image of the first viewpoint image to an image input signal constituting the second viewpoint image, in the addition processing mode.

In the first feature, the image control unit adjusts the image input signal constituting the second viewpoint image to alleviate a change in contrast of an image region where the contrast suddenly changes, in the first viewpoint image.

In the first feature, the image control unit adjusts the image input signal constituting the second viewpoint image to alleviate a change in contrast of an image region where the contrast suddenly changes, in the inverted image of the first viewpoint image.

In the first feature, the image control unit controls a process of alleviating the change in the contrast according to a position in an image.

In the first feature, the image control unit controls a size or a shape of an alleviation region, where the change in the contrast is to be alleviated, according to a position in an image.

In the first feature, the projection display apparatus comprises: a polarizing plate configured to align a polarization of the light emitted from the light source; and a liquid crystal element configured to switch the polarized light of the light emitted from the polarizing plate between a first polarized light and a second polarized light. The polarizing plate is configured to be moved out of an optical path of the light, which is emitted from the light source, up to a position in which the polarizing plate does not overlap the optical path of the light emitted from the light source.

In the first feature, the projection display apparatus comprises: a plate-like optical element having a polarizing region serving as the polarizing plate and a transparent region for adjusting a length of the optical path of the light emitted from the light source. The plate-like optical element is configured to be moved to a position in which the polarizing region does not overlap the optical path of the light emitted from the light source, and the transparent region overlaps the optical path of the light emitted from the light source, when the plate-like optical element is moved to the position in which the polarizing region does not overlap the optical path of the light emitted from the light source.

In the first feature, the projection display apparatus comprises: a control unit configured to sequentially perform a setting guidance process corresponding to a 3D mode selected from a plurality of 3D modes provided as 3D modes in which the stereoscopic image is displayed. The control unit outputs guidance information indicating a procedure for setting the selected 3D mode, and displays the stereoscopic image according to the selected 3D mode, in the setting guidance process.

In the first feature, the control unit specifies the 3D mode in which the stereoscopic image is displayed, and initially performs the setting guidance process corresponding to the specified 3D mode.

In the first feature, the plurality of 3D modes include two or more 3D modes of a polarized glasses system using polarized glasses, a shutter glasses system (1) for switching opening and closing of right and left shutters by a synchronization signal reflected by a screen, a shutter glasses system (2) for switching the opening and closing of the right and left shutters by a synchronization signal output from the projection display apparatus, and a shutter glasses system (3) for switching the opening and closing of the right and left shutters by a synchronization signal output from an external apparatus connected to the projection display apparatus.

A projection display apparatus according to a second feature has a plurality of 3D modes as 3D modes in which a stereoscopic image is displayed, the plurality of 3D modes including at least a 3D mode of a polarized glasses system using polarized glasses. The projection display apparatus turns on a crosstalk canceller, when the 3D mode of the polarized glasses system is selected.

In the second feature, a polarizing plate configured to align a polarization of image light of the stereoscopic image is inserted, when the 3D mode of the polarized glasses system is selected.

In the second feature, the 3D mode is switched to the 3D mode of the polarized glasses system according to insertion of the polarizing plate configured to align the polarization of the image light of the stereoscopic image.

### BRIEF DESCRIPTION OF THE DRAWINGS

FIG. 1 is a diagram illustrating a projection display apparatus 100 according to a first embodiment.

FIG. 2 is a diagram illustrating a control unit 200 according to the first embodiment.

FIG. 3 is a diagram illustrating the occurrence of crosstalk according to the first embodiment.

FIG. 4 is a diagram illustrating a subtraction processing mode according to the first embodiment.

FIG. 5 is a diagram illustrating the subtraction processing mode according to the first embodiment.

FIG. 6 is a diagram illustrating the subtraction processing mode according to the first embodiment.

FIG. 7 is a diagram illustrating the subtraction processing mode according to the first embodiment.

FIG. 8 is a diagram illustrating the subtraction processing mode according to the first embodiment.

FIG. 9 is a diagram illustrating an addition processing mode according to the first embodiment.

FIG. 10 is a diagram illustrating the addition processing mode according to the first embodiment.

FIG. 11 is a diagram illustrating the addition processing mode according to the first embodiment.

FIG. 12 is a diagram illustrating the addition processing mode according to the first embodiment.

FIG. 13 is a diagram illustrating the addition processing mode according to the first embodiment.

FIG. 14 is a diagram explaining the suppression amount of crosstalk according to the first embodiment.

FIG. 15 is a diagram explaining the suppression amount of crosstalk according to the first embodiment.

FIG. 16 is a diagram explaining the suppression amount of crosstalk according to the first embodiment.

FIG. 17 is a diagram illustrating an image example according to modification 1-1.

FIG. 18 is a diagram illustrating the image example according to the modification 1-1.

FIG. 19 is a diagram illustrating the image example according to the modification 1-1.

FIG. 20 is a diagram illustrating the projection display apparatus 100 according to a second embodiment.

FIG. 21 is a diagram illustrating the projection display apparatus 100 according to modification 2-1.

FIG. 22 is a diagram illustrating the projection display apparatus 100 according to the modification 2-1.

FIG. 23 is a diagram illustrating the projection display apparatus 100 according to the modification 2-1.

FIG. 24 is a diagram illustrating the projection display apparatus 100 according to the modification 2-1.

FIG. 25 is a diagram illustrating the projection display apparatus 100 according to the modification 2-1.

FIG. 26 is a diagram illustrating the projection display apparatus 100 according to the modification 2-1.

FIG. 27 is a diagram illustrating the projection display apparatus 100 according to the modification 2-1.

FIG. 28 is a diagram illustrating a plate-like optical element 270 according to a third embodiment.

FIG. 29 is a diagram illustrating the plate-like optical element 270 according to modification 3-1.

FIG. 30 is a diagram illustrating the plate-like optical element 270 according to modification 3-2.

FIG. 31 is a diagram illustrating the projection display apparatus 100 according to modification 3-3.

FIG. 32 is a diagram illustrating the projection display apparatus 100 according to the modification 3-3.

FIG. 33 is a diagram explaining a polarized glasses system according to a fourth embodiment.

FIG. 34 is a diagram explaining a shutter glasses system (1) according to the fourth embodiment.

FIG. 35 is a diagram explaining a shutter glasses system (2) according to the fourth embodiment.

FIG. 36 is a diagram explaining a shutter glasses system (3) according to the fourth embodiment.

FIG. 37 is a flowchart illustrating a setting guidance process according to the fourth embodiment.

FIG. 38 is a flowchart illustrating the setting guidance process according to the fourth embodiment.

FIG. 39 is a diagram illustrating an example of an error image according to the fourth embodiment.

### DETAILED DESCRIPTION OF THE EMBODIMENTS

Hereinafter, a projection display apparatus according to embodiments of the present invention will be described with reference to the drawings. It is noted that in the following description of the drawings, identical or similar numerals are assigned to identical or similar parts.

### Overview of First Embodiment

A projection display apparatus according to the first embodiment comprises: a light source, an imager configured to modulate light emitted from the light source, and a projection unit configured to project light modulated by the imager onto a projection plane. The projection display apparatus displays a stereoscopic image including a plurality of viewpoint images. The projection display apparatus comprises: an image control unit configured to control a second viewpoint image of the plurality of viewpoint images to suppress crosstalk of a first viewpoint image. The image control unit controls a suppression amount of crosstalk according to a position on the projection plane.

In the first embodiment, an image control unit controls the suppression amount of crosstalk according to a position on a projection plane. Accordingly, it is possible to appropriately control the crosstalk.

Specifically, in a (ultra) short focus-type projection display apparatus in which the distance between a projection unit and a projection plane is very short, an incident angle of image light with respect to the projection plane is significantly changed according to a position on the projection plane. Accordingly, it is preferable that the first embodiment is applied to the (ultra) short focus-type projection display apparatus. Here, as the incident angle of the image light with respect to the projection plane is increased, the disturbance of polarization is increased, resulting in an increase in the amount of crosstalk.

### First Embodiment

### (Projection Display Apparatus)

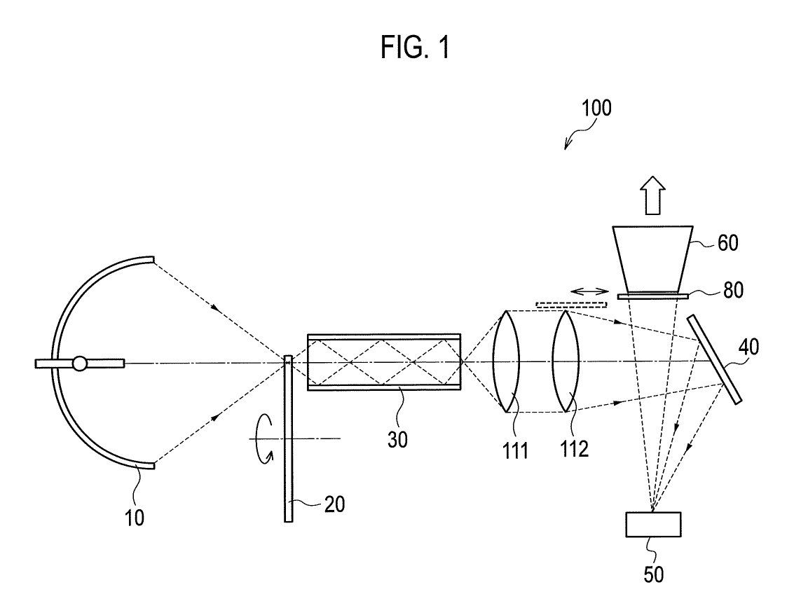

Hereinafter, a projection display apparatus according to a first embodiment will be described with reference to the accompanying drawings. FIG. 1 is a diagram illustrating a projection display apparatus 100 according to a first embodiment. In addition, in the first embodiment, a description will be provided for the case of using a red component light R, a green component light G, and a blue component light B.

As illustrated in FIG. 1, the projection display apparatus 100 includes a light source 10, a color wheel 20, a rod integrator 30, a reflection mirror 40, a DMD 50, a projection unit 60, and a liquid crystal element 80. In addition, the projection display apparatus 100 has a desired lens group (a lens 111 and a lens 112).

The light source 10 includes a UHP lamp and the like which emit whit light. That is, the white light emitted from the light source 10 includes at least a red component light R, a green component light G, and a blue component light B.

Here, the light source 10 has an oval reflector. The reflector has a first focal point, and a second focal point provided at the side of the color wheel 20 closer than the first focal point. The first focal point is a light emitting point of the white light. The second focal point is provided in the vicinity of the color wheel 20 which will be described later. That is, the white light emitted from the light source 10 is collected in the vicinity of the color wheel 20 which will be described later.

The color wheel 20 is configured to rotate about a rotational axis X parallel to an optical axis of the light source 10. The color wheel 20 includes a transparent member such as a glass plate and has a disc shape.

The color wheel 20 has a red region, a green region, and a blue region. The red region corresponds to a color filter configured to allow only the red component light R to pass therethrough. Similarly, the green region corresponds to a color filter configured to allow only the green component light G to pass therethrough, and the blue region corresponds to a color filter configured to allow only the blue component light B to pass therethrough.

In addition, the color wheel 20 may have regions for allowing color component lights (for example, a white component light, a yellow component light, a cyan component light, and a magenta component light), other than the red component light R, the green component light G, and the blue component light B, to pass therethrough, in addition to the red region, the green region, and the blue region.

Here, the white light emitted from the light source 10 is collected in the vicinity of the transparent member constituting the color wheel 20. In other words, the transparent member constituting the color wheel 20 is arranged in the vicinity of the above-mentioned second focal point. In this way, it is possible to manufacture the color wheel 20 in a small size.

Furthermore, the rotational axis X is not the optical axis of the light source 10, and may have a slope with respect to the optical axis of the light source 10. For example, the wheel surface of the color wheel 20 may have a slope of 45 degrees with respect to the optical axis of the light source 10. In such a case, the color wheel 20 may be a reflective color wheel other than a transparent color wheel.

The rod integrator 30 is a solid rod including a transparent member such as glass. The rod integrator 30 uniformizes light incident thereto. In addition, the rod integrator 30 may be a hollow rod in which an inner wall thereof includes a mirror surface.

The reflection mirror 40 reflects light, which is emitted from the rod integrator 30, toward the DMD 50.

The DMD 50 is a display element including a plurality of micromirrors. Each of the plurality of micromirrors is configured to be movable. Each micromirror basically corresponds to one pixel. The DMD 50 switches whether to reflect light toward the projection unit 60 by changing an angle of each micromirror.

The projection unit 60 projects light (image light), which is reflected by the micromirrors provided in the DMD 50, onto a projection plane (not illustrated).

The liquid crystal element 80 switches polarized light of light emitted from the projection unit 60 between a first polarized light and a second polarized light in the case of a 3D mode. Specifically, the liquid crystal element 80 switches the polarized light of the light, which is emitted from the projection unit 60, according to a voltage applied to the liquid crystal element 80. For example, when a voltage is applied to the liquid crystal element 80, the liquid crystal element 80 aligns the polarization of the light emitted from the projection unit 60 to the first polarized light. Meanwhile, when no voltage is applied to the liquid crystal element 80, the liquid crystal element 80 aligns the polarization of the light emitted from the projection unit 60 to the second polarized light.

For example, when the first polarized light is a linearly polarized light in the vertical direction, the second polarized light is a linearly polarized light in the horizontal direction. Furthermore, the light emitted from the projection unit 60 may be a linearly polarized light, the first polarized light may be a counterclockwise circularly polarized light (or a clockwise circularly polarized light), and the second polarized light may be a clockwise circularly polarized light (or a counterclockwise circularly polarized light). In this case, when the liquid crystal element 80 performs the switching of the first polarized light and the second polarized light, a voltage is applied. However, it is possible to obtain a merit that crosstalk is reduced.

In addition, it should be noted that an observer puts on polarized glasses corresponding to the type of the first polarized light and the second polarized light, and views a stereoscopic image through the polarized glasses.

In the first embodiment, the liquid crystal element 80 is arranged between the DMD 50 and the projection unit 60.

### (Configuration of Control Unit)

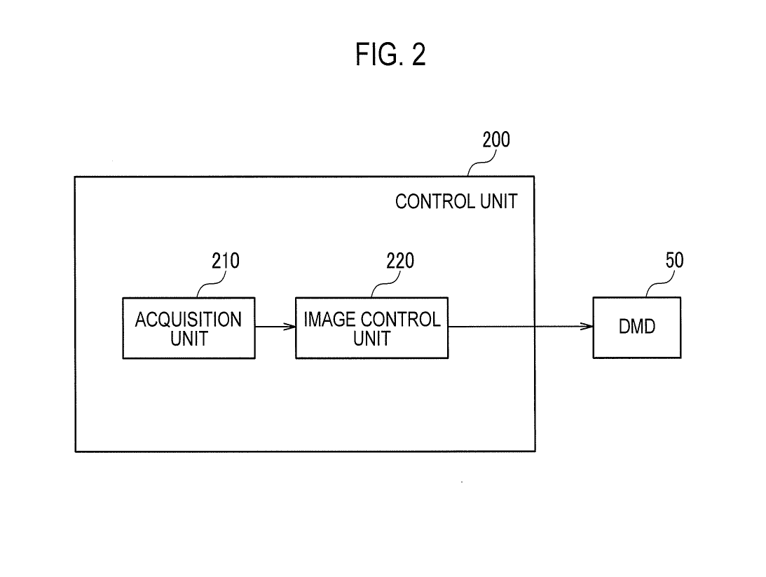

Hereinafter, the control unit according to the first embodiment will be described with reference to the accompanying drawings. FIG. 2 is a diagram illustrating a control unit 200 according to the first embodiment. The control unit 200 is provided in the projection display apparatus 100. As illustrated in FIG. 2, the control unit 200 includes an acquisition unit 210 and an image control unit 220.

The acquisition unit 210 acquires an image input signal constituting a stereoscopic image. For example, the acquisition unit 210 acquires an image input signal from an apparatus such as a television tuner, a DVD player or a personal computer.

The image control unit 220 controls a viewpoint image displayed on the DMD 50. For example, the image control unit 220 controls the suppression amount of crosstalk according to the position on the projection plane. In addition, the suppression amount of crosstalk, for example, corresponds to the amount of subtraction (the amount of crosstalk) in a subtraction processing mode which will be described later. Alternatively, the suppression amount of crosstalk, for example, corresponds to the amount of addition (the amount of inverted crosstalk) in an addition processing mode which will be described later.

The suppression amount of crosstalk is determined according to an incident angle of image light with respect to the projection plane, as will be described later. As the incident angle of the image light with respect to the projection plane is increased, a large value is set as the suppression amount of crosstalk.

Furthermore, the image control unit 220 controls a second viewpoint image (here, a right eye viewpoint image) to suppress crosstalk of a first viewpoint image (here, a left eye viewpoint image). The image control unit 220 may switch a control mode for suppressing crosstalk between the subtraction processing mode and the addition processing mode according to the image input signal constituting the stereoscopic image.

Specifically, in the subtraction processing mode, the image control unit 220 subtracts the amount of crosstalk corresponding to the first viewpoint image from an image input signal constituting the second viewpoint image. Here, it is preferable that the image control unit adjusts the image input signal constituting the second viewpoint image to alleviate a change in contrast of an image region, where the contrast suddenly changes, in the first viewpoint image.

Meanwhile, in the addition processing mode, the image control unit 220 adds the amount of inverted crosstalk corresponding to an inverted image of the first viewpoint image to the image input signal constituting the second viewpoint image. Here, it is preferable that the image control unit adjusts the image input signal constituting the second viewpoint image to alleviate a change in contrast of an image region, where the contrast suddenly changes, in the inverted image of the first viewpoint image.

In addition, the inverted image of the first viewpoint image includes an inverted image input signal obtained by inverting an image input signal constituting the first viewpoint image.

Here, after the image control unit 220 subtracts the amount of crosstalk from the image input signal constituting the second viewpoint image, in the case in which there exists no pixel in which a pixel value becomes less than a lower limit value, the subtraction processing mode is employed instead of the addition processing mode. In such a case, after the image control unit 220 subtracts the amount of crosstalk from the image input signal constituting the second viewpoint image, since there exists no pixel in which the pixel value becomes less than the lower limit value, it should be noted that “ghost”, “misadjusted black level”, and “white saturation” do not occur.

After the image control unit 220 subtracts the amount of crosstalk from the image input signal constituting the second viewpoint image, in the case in which there exists a pixel in which the pixel value becomes less than the lower limit value, if the amount of inverted contrast is added to the image input signal constituting the second viewpoint image, when there exists a pixel in which a pixel value exceeds an upper limit value, the subtraction processing mode is employed instead of the addition processing mode. In such a case, if the image control unit 220 adds the amount of inverted contrast to the image input signal constituting the second viewpoint image, since there exists the pixel in which the pixel value exceeds the upper limit value, the subtraction processing mode is employed, so that the “white saturation” is suppressed. This should be borne in mind. In addition, in the subtraction processing mode, since a change in contrast of an image region, where contrast suddenly changes, is alleviated, the “ghost” is suppressed. However, the “misadjusted black level” is not avoidable.

When there exists the pixel in which the pixel value becomes less than the lower limit value after the image control unit 220 subtracts the amount of crosstalk from the image input signal constituting the second viewpoint image, and when there exists no pixel in which the pixel value exceeds the upper limit value after the image control unit 220 adds the amount of inverted contrast to the image input signal constituting the second viewpoint image, the addition processing mode is employed instead of the subtraction processing mode. In such a case, after the image control unit 220 adds the amount of inverted contrast to the image input signal constituting the second viewpoint image, since there exists no pixel in which the pixel value exceeds the upper limit value, even when the addition processing mode is employed, it should be noted that the “white saturation” does not occur.

### (Occurrence of Crosstalk)

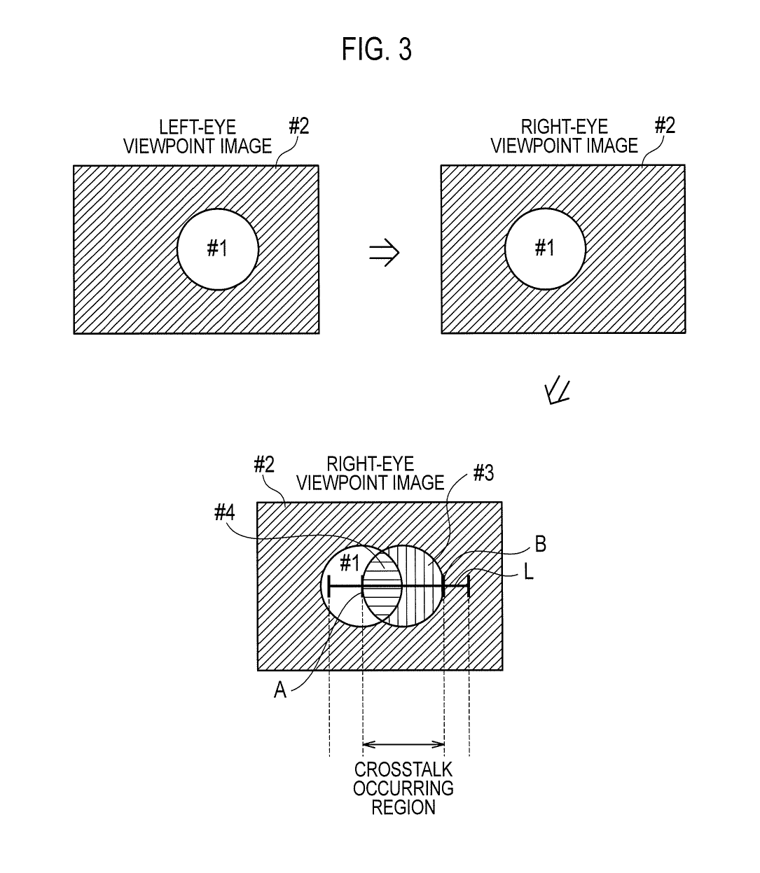

Hereinafter, the occurrence of crosstalk will be described with reference to FIG. 3. For the simplification of description, FIG. 3 illustrates the case, in which each of the first viewpoint image (here, the left eye viewpoint image) and the second viewpoint image (here, the right eye viewpoint image) includes an image region #1 and an image region #2, as an example. The image region #1, for example, is an image region (an object image region) with high luminance, and a parallax exists between the left eye viewpoint image and the right eye viewpoint image. The image region #2, for example, is an image region (a background image region) with low luminance, and no parallax exists between the left eye viewpoint image and the right eye viewpoint image.

In such a case, if there occurs crosstalk of the left eye viewpoint image (interference to the right eye viewpoint image from the left eye viewpoint image), luminance of an image region #3 and an image region #4 in the right eye viewpoint image is increased. In other words, on the straight line L, crosstalk occurs between a pixel A and a pixel B.

### (Subtraction Processing Mode)

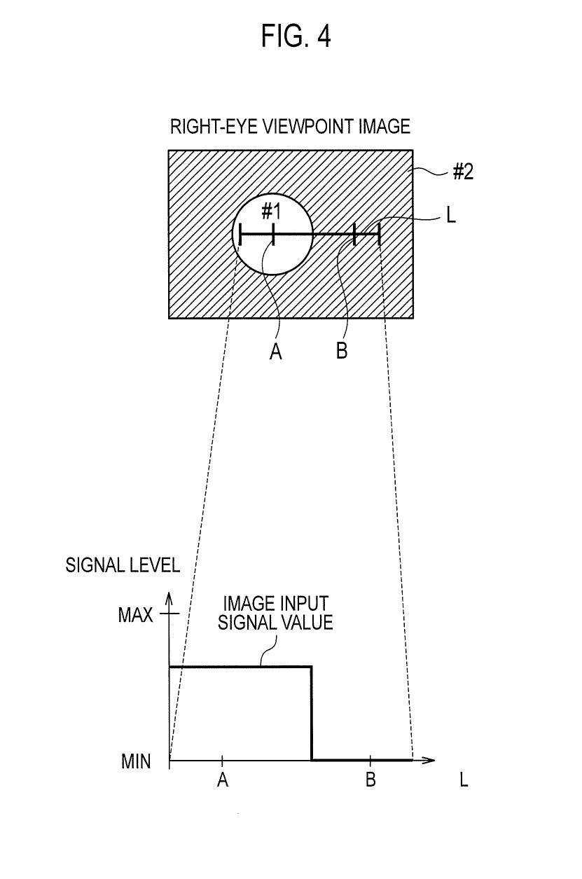

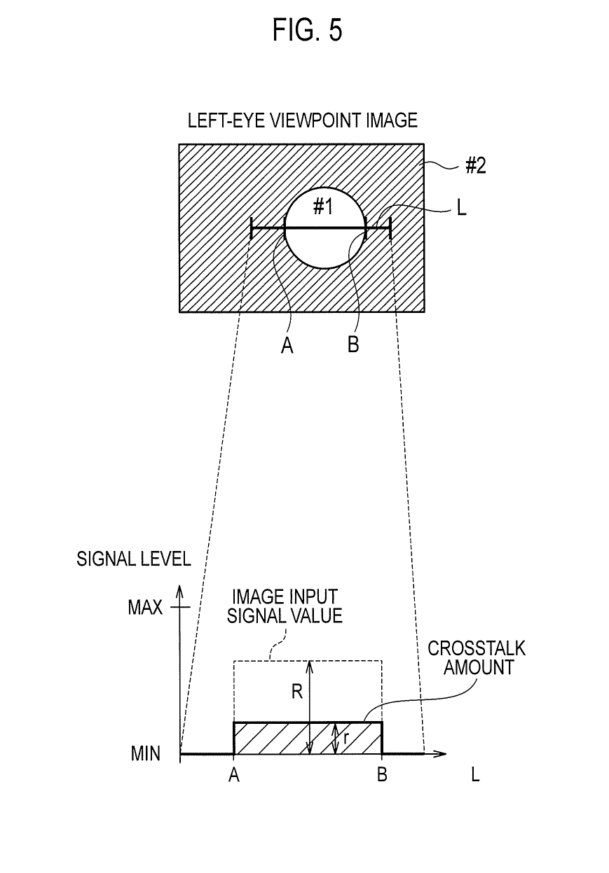

Hereinafter, the subtraction processing mode will be described with reference to FIG. 4 to FIG. 8. Here, the right eye viewpoint image includes the image region #1 and the image region #2 as illustrated in FIG. 4. The amount of crosstalk corresponding to the left eye viewpoint image is obtained by multiplying an image input signal value (for example, luminance) of the image region #1 by a constant ratio “r/R” as illustrated in FIG. 5.

Here, since a signal level of an image input signal constituting the image region #2 of the right eye viewpoint image is “MIN (for example, “0”)”, it is not possible to subtract the amount of crosstalk corresponding to the left eye viewpoint image from the image input signal constituting the image region #2 of the right eye viewpoint image.

Accordingly, the image control unit 220 calculates a signal value (an addition signal value) to be added to the image input signal constituting the right eye viewpoint image, based on the subtraction of the amount of crosstalk corresponding to the left eye viewpoint image.

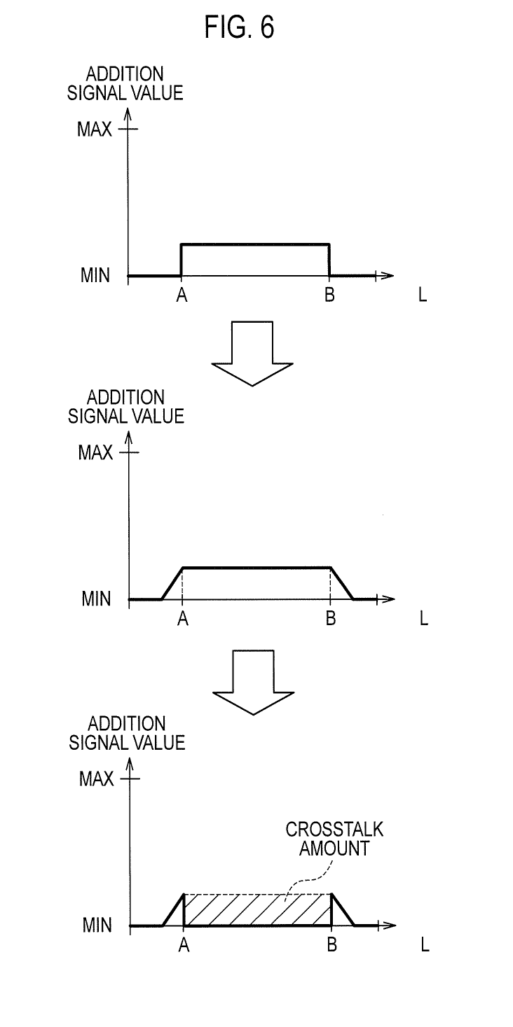

As illustrated in FIG. 6, firstly, the image control unit 220 sets the amount of crosstalk corresponding to the left eye viewpoint image as an addition signal value. Secondly, the image control unit 220 corrects the addition signal value such that a change in an image to be displayed is in a predetermined threshold value with respect to neighboring pixels of a pixel A and a pixel B, specifically, a change in an addition signal value between the neighboring pixels is in the predetermined threshold value. Thirdly, the image control unit 220 subtracts the amount of crosstalk corresponding to the left eye viewpoint image from the addition signal value.

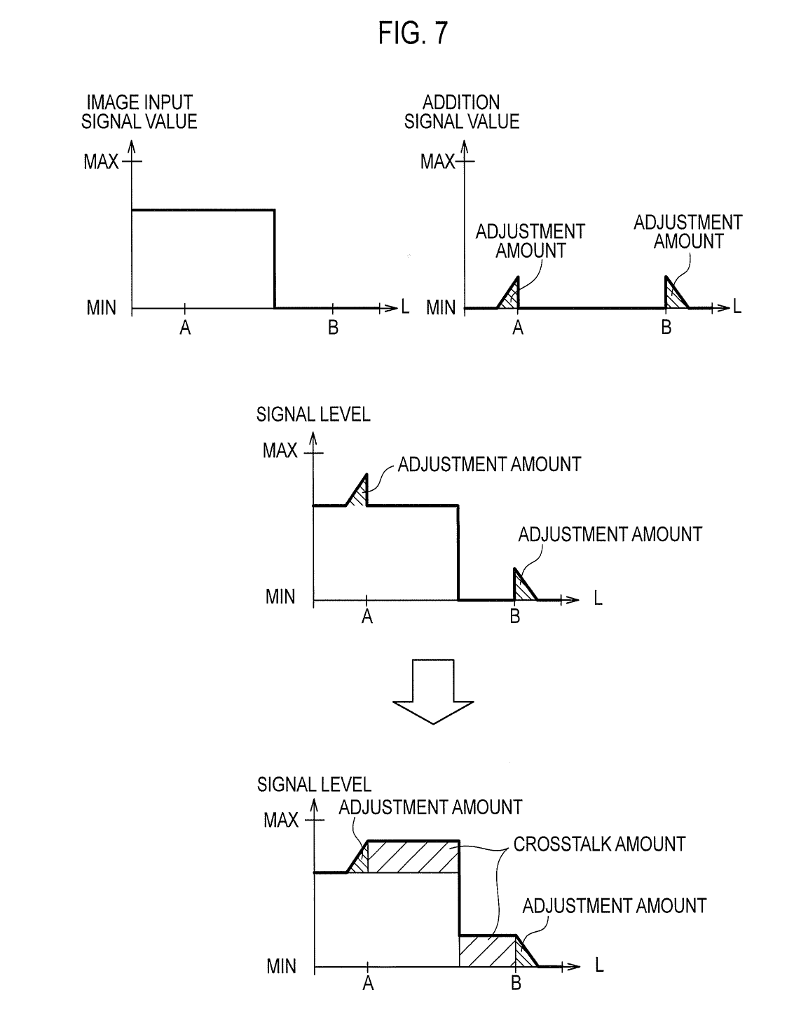

Next, the image control unit 220 adds the addition signal value to the image input signal constituting the right eye viewpoint image as illustrated in FIG. 7. Finally, the amount of crosstalk corresponding to the left eye viewpoint image is added, so that a signal level of an actual right eye viewpoint image to be viewed by a user is determined.

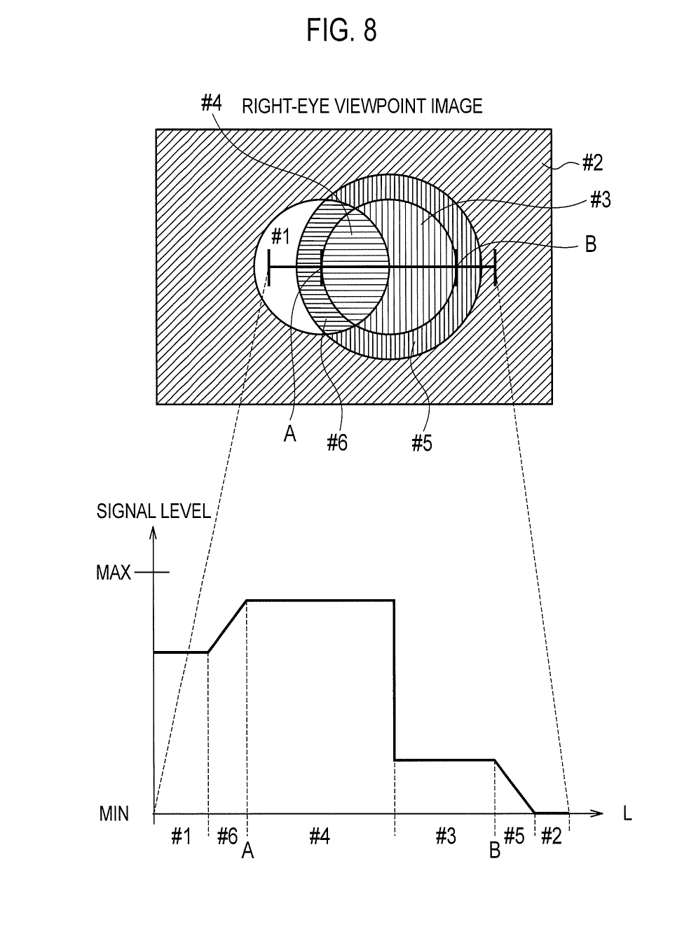

For example, as illustrated in FIG. 8, the actual right eye viewpoint image to be viewed by a user is provided with an image region #5 and an image region #6, where a change in contrast has been alleviated, around an image region #3 and an image region #4 (a region where crosstalk has occurred). As described above, by the image region #5 and the image region #6 where the change in the contrast has been alleviated, the outline of a “ghost” is blurred, so that the ghost” is reduced.

In addition, an image region, where a change in contrast is alleviated, is an image region where an image input signal is adjusted. For example, the image region, where the change in the contrast is alleviated, is the image region #5 and the image region #6.

### (Addition Processing Mode)

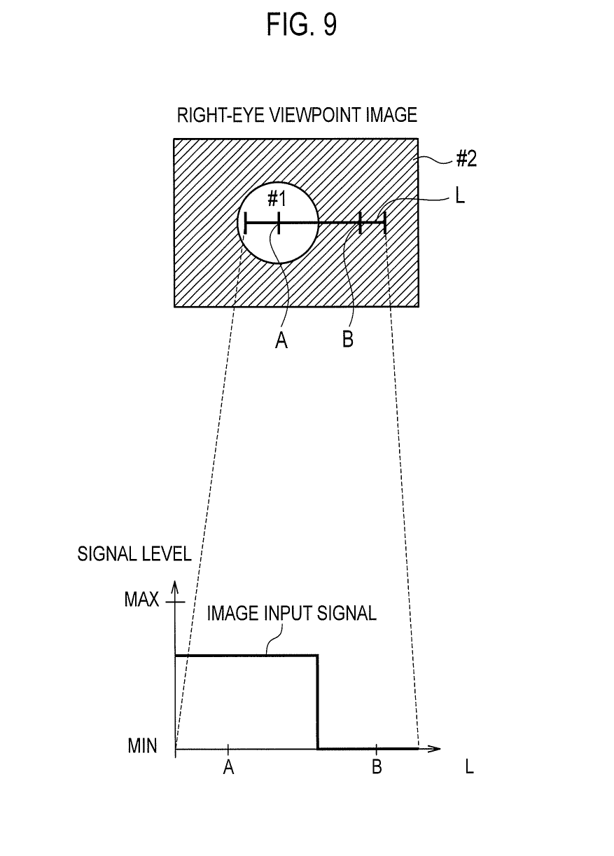

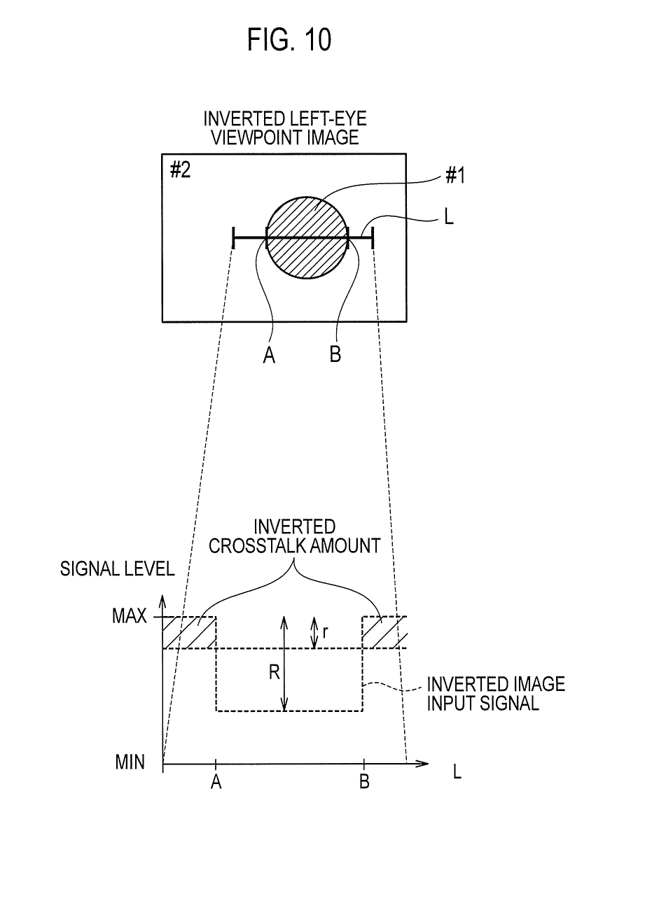

Hereinafter, the addition processing mode will be described with reference to FIG. 9 to FIG. 13. Here, the right eye viewpoint image includes the image region #1 and the image region #2 as illustrated in FIG. 9. The amount of inverted crosstalk corresponding to an inverted image of the left eye viewpoint image is obtained by multiplying an inverted image input signal value (for example, luminance) of the image region #1 by a constant ratio “r/R” as illustrated in FIG. 10. The constant ratio “r/R” is determined by the performance of a display or the performance of glasses.

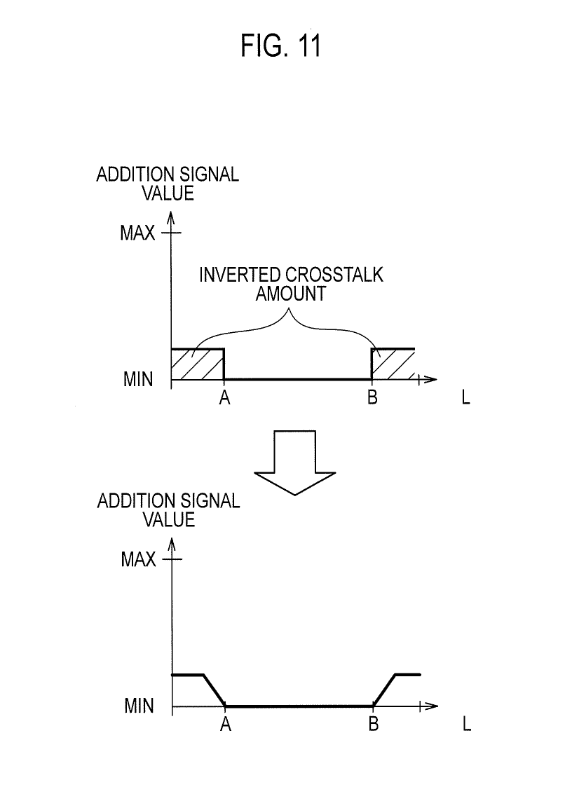

As illustrated in FIG. 11, firstly, the image control unit 220 sets the amount of inverted crosstalk corresponding to the inverted image of the left eye viewpoint image as an addition signal value. Secondly, the image control unit 220 corrects the addition signal value such that a change in an image to be displayed is in a predetermined threshold value with respect to neighboring pixels of a pixel A and a pixel B, specifically, a change in an addition signal value between the neighboring pixels is in the predetermined threshold value.

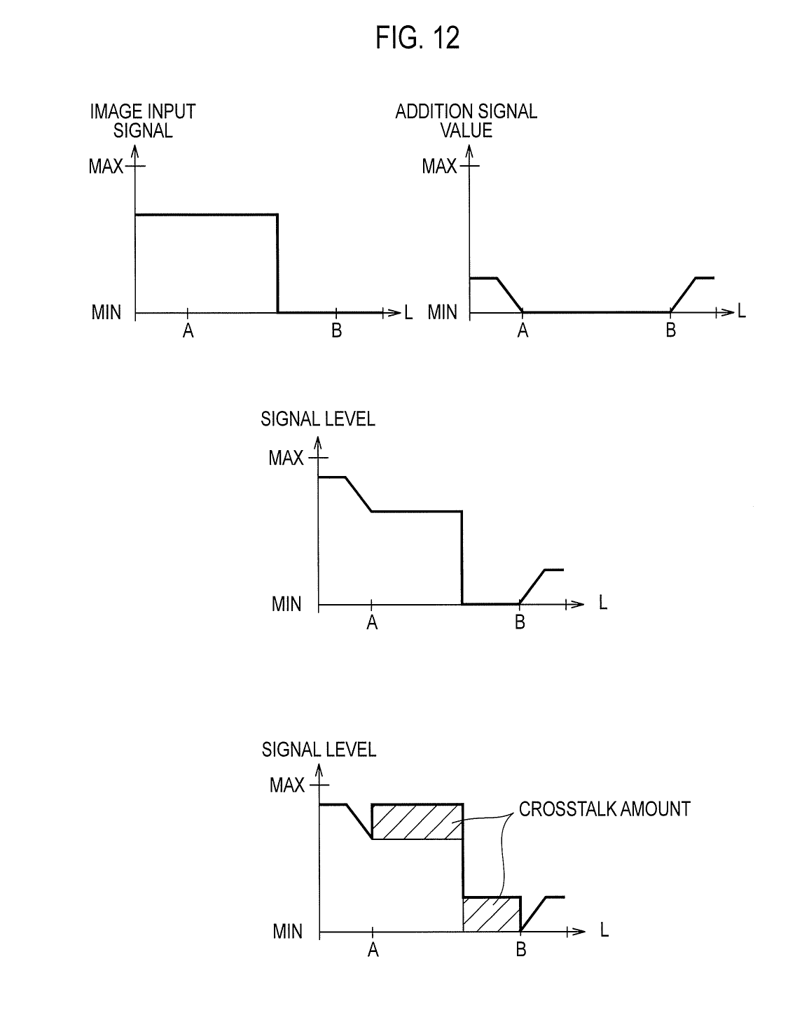

Next, the image control unit 220 adds the addition signal value to the image input signal constituting the right eye viewpoint image as illustrated in FIG. 12. Finally, the amount of crosstalk corresponding to the left eye viewpoint image is added, so that a signal level of an actual right eye viewpoint image to be viewed by a user is determined.

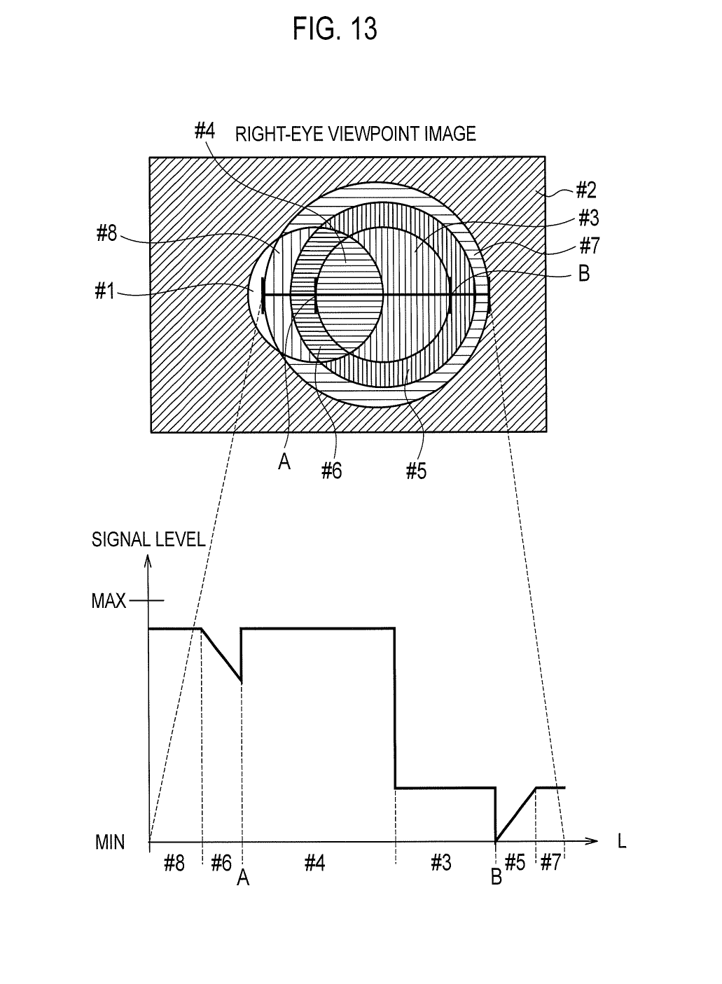

For example, as illustrated in FIG. 13, the actual right eye viewpoint image to be viewed by a user is provided with the image region #5 and the image region #6, where a change in contrast has been alleviated, around the image region #3 and the image region #4 (a region where crosstalk has occurred). An image region #7 and an image region #8, to which the addition signal value has been added, are provided around the image region #5 and the image region #6.

In addition, an image region, where a change in contrast is alleviated, is an image region where an image input signal is adjusted. For example, the image region, where the change in the contrast is alleviated, is the image region #5 and the image region #6.

### (Suppression Amount of Crosstalk)

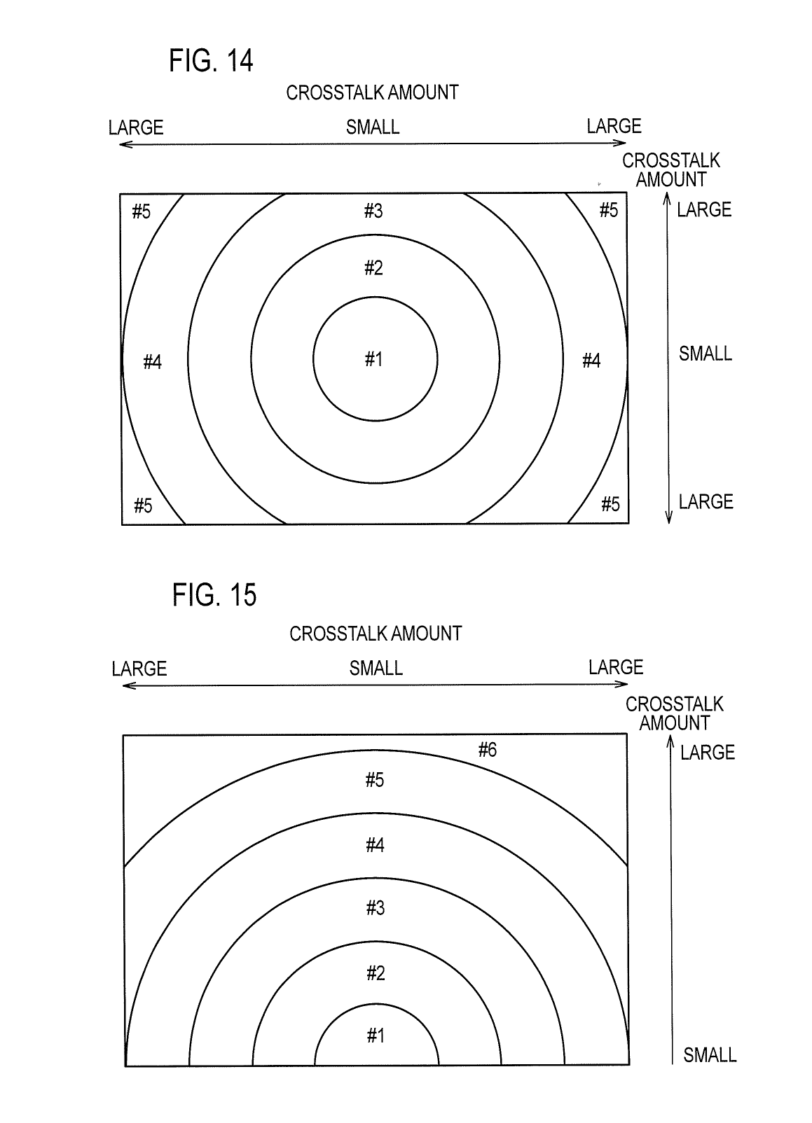

Hereinafter, the suppression amount of crosstalk will be described with reference to FIG. 14 and FIG. 15.

Firstly, a description will be provided for the case in which image light is projected onto a projection plane from a front of the projection plane. In such a case, an incident angle of the image light with respect to the projection plane is minimal at the center part of the projection plane. Furthermore, the incident angle of the image light with respect to the projection plane is increased the farther from the center part of the projection plane.

Here, as the incident angle of the image light with respect to the projection plane is increased, the disturbance of polarization is increased, resulting in an increase in the amount of crosstalk the farther from the center of the projection plane.

Thus, as illustrated in FIG. 14, the projection plane is divided into regions (a region #1 to a region #5) on a concentric circle about the center part of the projection plane. The suppression amount of crosstalk is sequentially increased from the region #1 to the region #5.

Secondly, a description will be provided for the case in which image light is projected onto the projection plane from the lower center of the projection plane. In such a case, an incident angle of the image light with respect to the projection plane is minimal at the central lower part of the projection plane. Furthermore, the incident angle of the image light with respect to the projection plane is increased the farther from the central lower part of the projection plane.

Thus, as illustrated in FIG. 15, the projection plane is divided into regions (a region #1 to a region #6) on a concentric circle about the central lower part of the projection plane. The suppression amount of crosstalk is sequentially increased from the region #1 to the region #6.

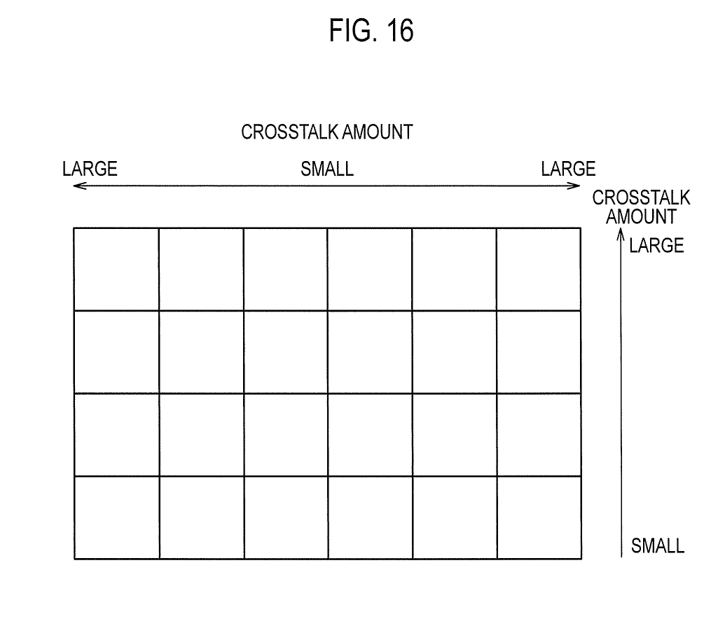

In addition, in the above-mentioned example, the projection plane is divided into regions on the concentric circle. However, the present embodiment is not limited thereto. Specifically, the projection plane may be divided into rectangular blocks as illustrated in FIG. 16. The suppression amount of crosstalk in each block is determined according to the incident angle of the image light with respect to the projection plane.

### (Operation and Effect)

In the first embodiment, the image control unit 220 controls the suppression amount of crosstalk according to the position on the projection plane. Accordingly, it is possible to appropriately control the crosstalk.

Specifically, in the (ultra) short focus-type projection display apparatus 100 in which the distance between the projection unit 60 and the projection plane is very short, the incident angle of the image light with respect to the projection plane is significantly changed according to the position on the projection plane. Accordingly, it is preferable that the first embodiment is applied to the (ultra) short focus-type projection display apparatus 100.

In the first embodiment, the image control unit 220 switches the control mode for suppressing crosstalk between the subtraction processing mode and the addition processing mode according to the image input signal constituting the stereoscopic image. Accordingly, the “ghost”, the “misadjusted black level”, and the “white saturation” are suppressed.

### Modification 1-1

Hereinafter, a modification 1-1 of the first embodiment will be described. Hereinafter, a difference from the first embodiment will be mainly described.

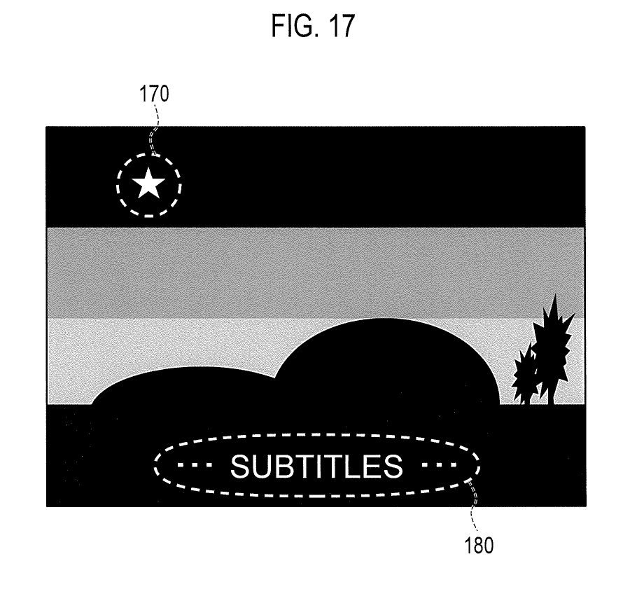

Specifically, in the modification 1-1, the above-mentioned image control unit 220 controls a process of alleviating a change in contrast according to a position in an image. In addition, in the modification 1-1, for example, a night view image will be described as an example as illustrated in FIG. 17 to FIG. 19. This image includes mountain and tree as background, and has a gradation in which luminance gradually changes. Here, in a dark region (a night sky), a star 170 twinkles. Furthermore, in the dark region, a white caption 180 is displayed. As described above, a region, where the luminance of the vicinity (background) of a specific region is lower than a predetermined threshold value and the luminance of the specific region is higher than the predetermined threshold value, has been mainly considered.

Firstly, the image control unit 220 alleviates a change in the contrast of the specific region, and does not alleviate a change in the contrast of other regions other than the specific region.

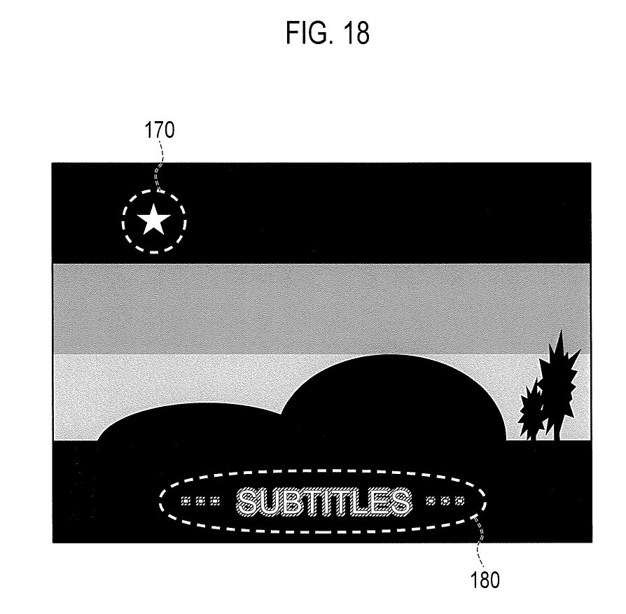

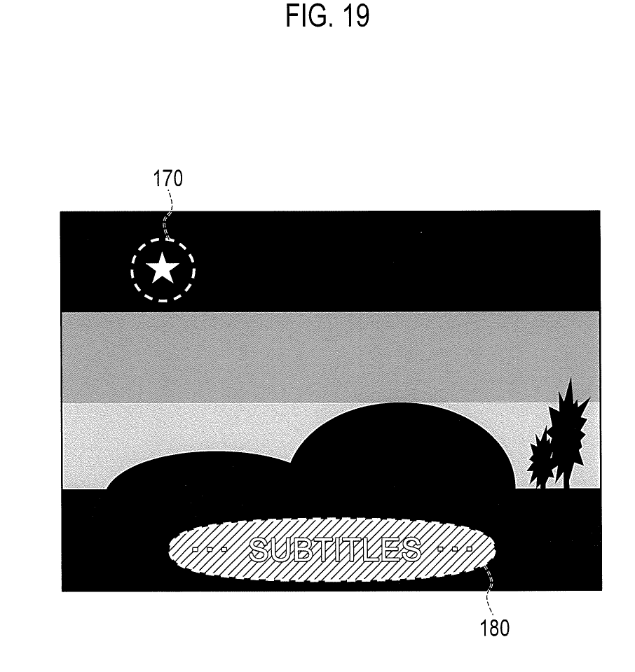

Secondly, the image control unit 220 sets a region, which is larger than an alleviation region corresponding to another region other than the specific region, as an alleviation region corresponding to the specific region. In addition, the alleviation region is an image region where a change in contrast is to be alleviated. For example, as illustrated in FIG. 18, the alleviation region is provided around the white caption 180.

Thirdly, the image control unit 220 sets a region, which has a shape (for example, an oval shape, a rectangular shape and the like) determined in advance, as the alleviation region corresponding to the specific region. For example, as illustrated in FIG. 19, an alleviation region having an oval shape is provided to surround the white caption 180.

In addition, the specific region, for example, is determined as follows. (1) The image control unit 220 extracts a frequency component of each line (for example, each line in the horizontal direction) included in an image, and specifies a region, where the number of lines is equal to or more than a predetermined number, as the specific region, wherein the lines have an average value of frequency components higher than a predetermined threshold value. Alternatively, (2) the image control unit 220 specifies a region determined in advance as the specific region. In addition, there is a case in which a region where the caption 180 is displayed is determined in advance, and the method (2) is effective for this case.

Fourthly, the image control unit 220 calculates a representative value (a sum value or an average value) of contrast for each plurality of image regions constituting an image, and sets a larger region, as an alleviation region, according to an image region having a larger representative value of the contrast.

Fifthly, the image control unit 220 sets a small region as the alleviation region as it goes to the center of the image, and sets a large region as the alleviation region as it goes to the end of the image.

### Overview of Second Embodiment

A projection display apparatus according to the second embodiment comprises: a polarizing plate configured to align a polarization of the light emitted from the light source; and a liquid crystal element configured to switch the polarized light of the light emitted from the polarizing plate between a first polarized light and a second polarized light. The polarizing plate is configured to be moved out of an optical path of the light, which is emitted from the light source, up to a position in which the polarizing plate does not overlap the optical path of the light emitted from the light source.

In the second embodiment, a polarizing plate is configured to be moved out of an optical path of light, which is emitted from a light source, up to a position in which the polarizing plate does not overlap the optical path of the light emitted from the light source. Accordingly, in a 2D mode in which a two-dimensional image is displayed, the polarizing plate is moved from the optical path of the light emitted from the light source, so that it is possible to suppress a reduction of the luminance of an image in the 2D mode.

### (Projection Display Apparatus)

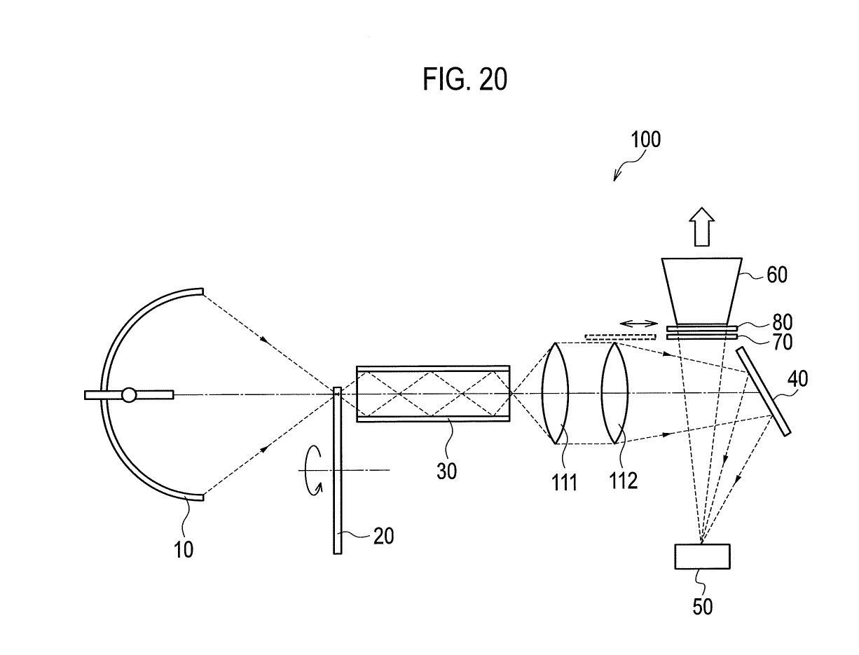

Hereinafter, a projection display apparatus according to the second embodiment will be described with reference to the accompanying drawings. FIG. 20 is a diagram illustrating the projection display apparatus 100 according to the first embodiment. As illustrated in FIG. 20, the projection display apparatus 100 includes a polarizing plate 70, in addition to the configuration illustrated in FIG. 1. Here, there is no polarizing plate for aligning the polarization of the light emitted from the light source 10 in FIG. 1, the polarizing plate 70 for aligning the polarization of the light emitted from the light source 10 is provided in FIG. 20.

The polarizing plate 70 is an optical element for aligning the polarization of the light emitted from the light source 10. Specifically, the polarizing plate 70 allows only a predetermined polarized light component to pass therethrough. In addition, the predetermined polarized light component, for example, is a component having a linearly polarized light in a predetermined direction. It is sufficient if the polarizing plate 70 is arranged at the side of the light source 10 on the optical path of the light emitted from the light source 10 more than the liquid crystal element 80. That is, it is sufficient if the polarizing plate 70 is arranged at a front stage of the liquid crystal element 80.

In the first embodiment, the polarizing plate 70 is arranged on the optical path of the light emitted from the DMD 50, and aligns the polarization of the light emitted from the DMD 50.

Here, the polarizing plate 70 is configured to be moved out of the optical path of the light, which is emitted from the light source 10, up to a position in which the polarizing plate 70 does not overlap the optical path (here, the optical path of the light emitted from the DMD 50) of the light emitted from the light source 10.

In addition, the polarizing plate 70 may be manually moved to the position in which the polarizing plate 70 does not overlap the optical path of the light emitted from the light source 10. Alternatively, the polarizing plate 70 may be electrically moved to the position in which the polarizing plate 70 does not overlap the optical path of the light emitted from the light source 10. Preferably, the projection display apparatus 100 has a space for accommodating the polarizing plate 70 out of the optical path of the light emitted from the light source 10.

Furthermore, when the polarizing plate 70 is arranged on the optical path of the light emitted from the light source 10, a 3D mode is applied to display a stereoscopic image. Meanwhile, when the polarizing plate 70 is out of the optical path of the light emitted from the light source 10, a 2D mode is applied to display a two-dimensional image.

In addition, in the 3D mode, a plurality of viewpoint images (for example, in two viewpoints, a right eye viewpoint image and a left eye viewpoint image) are configured to be guided to the right eye and the left eye, so that an observer views a stereoscopic image. In addition, the plurality of viewpoint images are two-dimensional images.

### (Operation and Effect)

In the second embodiment, the polarizing plate 70 is configured to be moved out of the optical path of the light, which is emitted from the light source 10, up to the position in which the polarizing plate 70 does not overlap the optical path of the light emitted from the light source 10. Accordingly, in the 2D mode, the polarizing plate 70 is moved from the optical path of the light emitted from the light source 10, so that it is possible to suppress a reduction of the luminance of an image in the 2D mode.

In the first embodiment, the DMD 50 is used as an imager. That is, it should be noted that the DMD 50 has no function of aligning the polarization of the light emitted from the DMD 50.

### Modification 2-1

Hereinafter, the modification 2-1 of the second embodiment will be described. Hereinafter, a difference from the second embodiment will be mainly described.

Specifically, in the modification 2-1, arrangement variation of the polarizing plate 70 and the liquid crystal element 80 will be described.

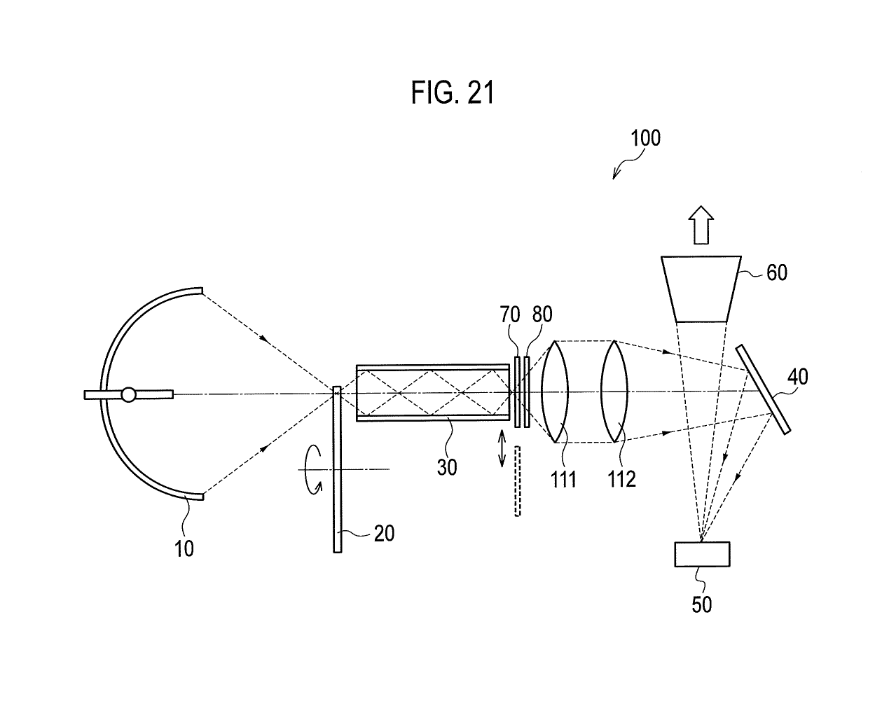

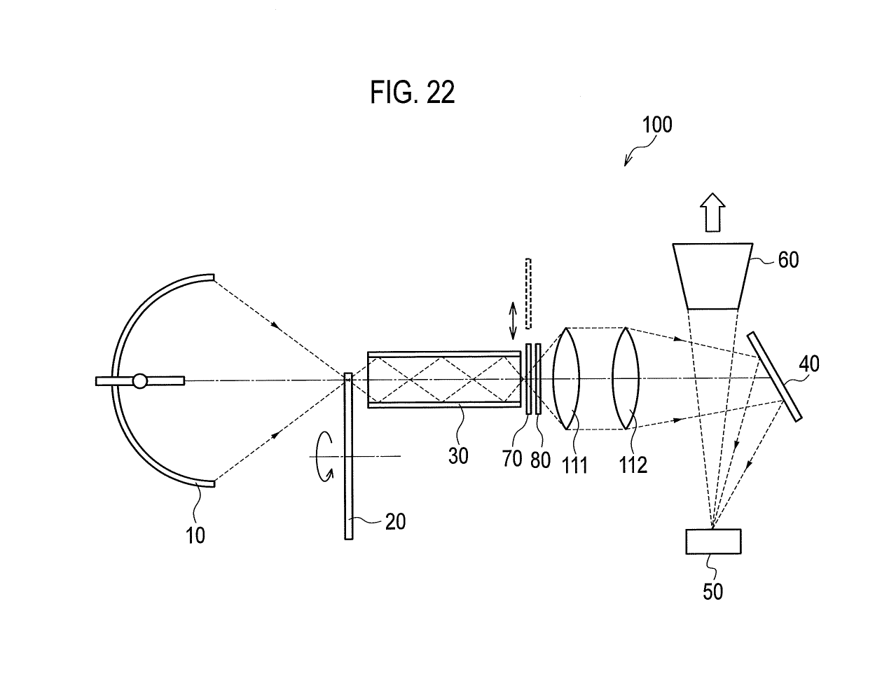

As illustrated in FIG. 21 and FIG. 22, the polarizing plate 70, which is arranged at a light emitting side of the rod integrator 30, may align the polarization of the light emitted from the rod integrator 30. The liquid crystal element 80 may be arranged between the rod integrator 30 and the reflection mirror 40. In addition, it should be noted that the movement direction of the polarizing plate 70 is arbitrary as illustrated in FIG. 21 and FIG. 22.

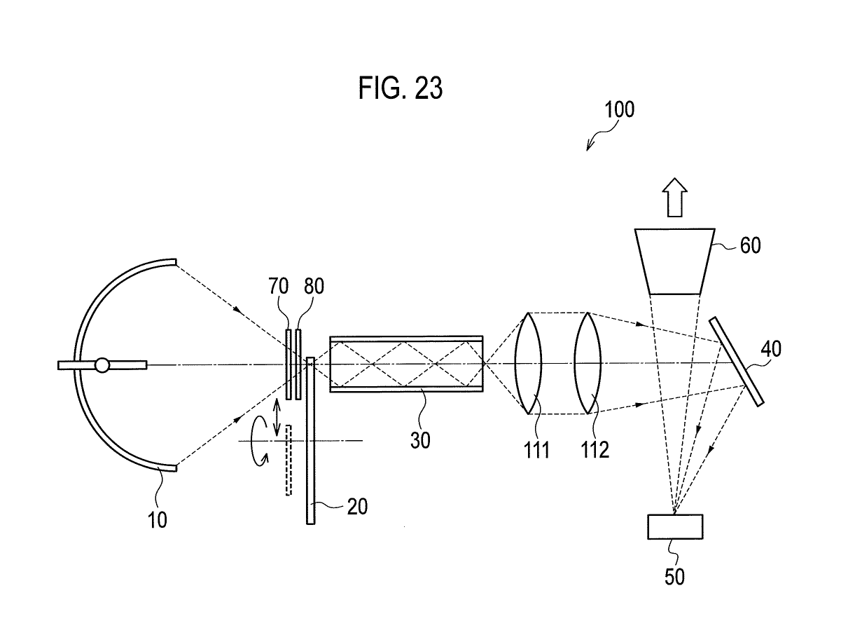

Alternatively, as illustrated in FIG. 23, the polarizing plate 70, which is arranged at a light incident side of the rod integrator 30, may align the polarization of the light emitted from the light source 10. The liquid crystal element 80 may be arranged between the light source 10 and the color wheel 20.

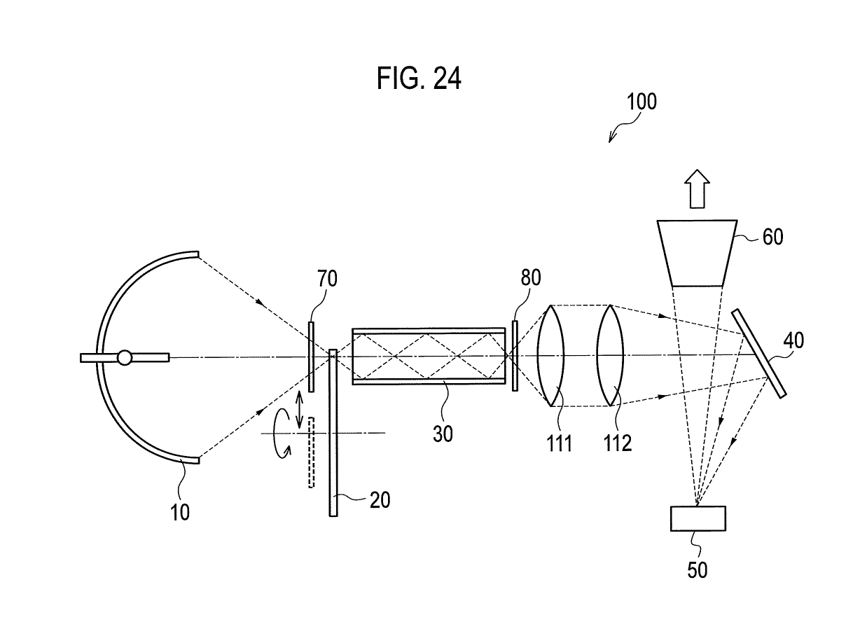

Alternatively, as illustrated in FIG. 24, the polarizing plate 70, which is arranged at the light incident side of the rod integrator 30, may align the polarization of the light emitted from the light source 10. The liquid crystal element 80 may be arranged between the rod integrator 30 and the reflection mirror 40. As described above, the polarizing plate 70 may not be arranged adjacent to the liquid crystal element 80.

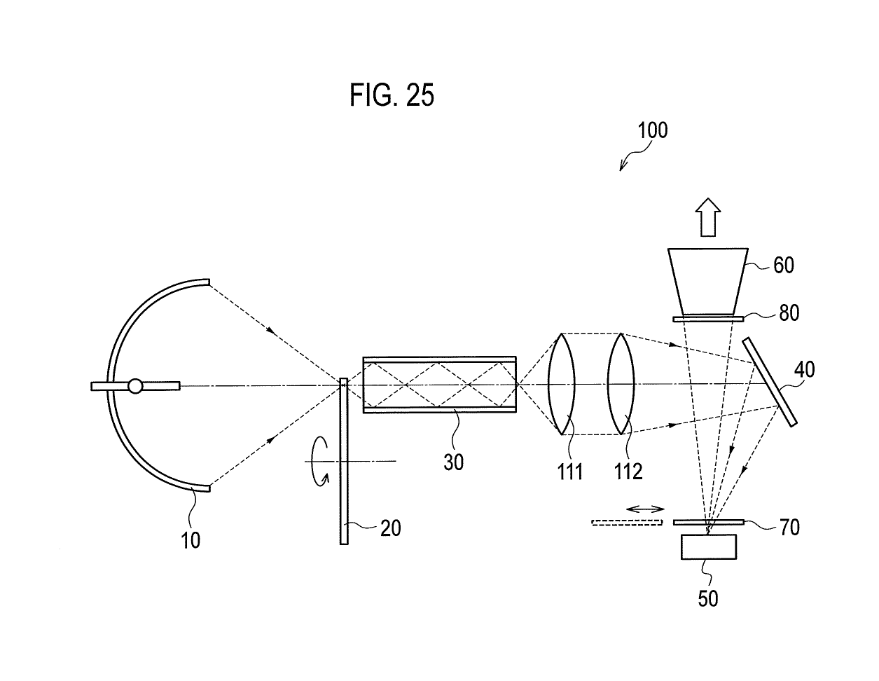

Alternatively, as illustrated in FIG. 25, the polarizing plate 70, which is arranged at a light emitting side of the DMD 50, may align the polarization of the light emitted from the DMD 50. The liquid crystal element 80 may be arranged at a light incident side of the projection unit 60.

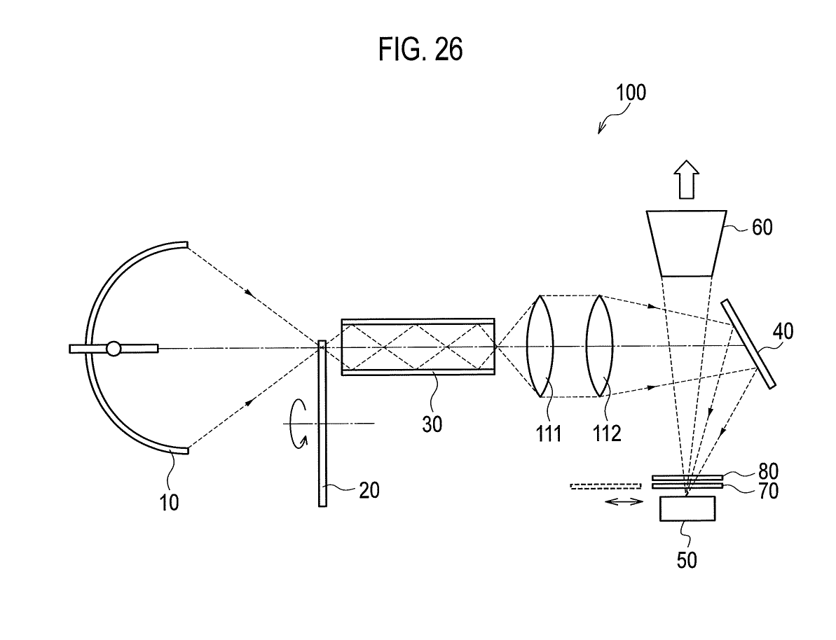

Alternatively, as illustrated in FIG. 26, the polarizing plate 70, which is arranged at the light emitting side of the DMD 50, may align the polarization of the light emitted from the DMD 50. The liquid crystal element 80 may be arranged at the light emitting side of the DMD 50.

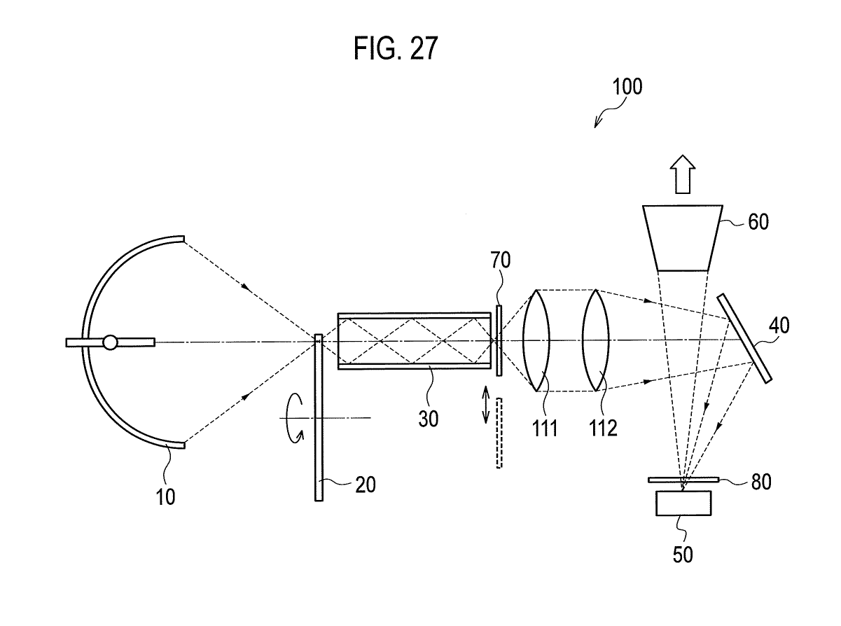

Alternatively, as illustrated in FIG. 27, the polarizing plate 70, which is arranged at the light emitting side of the rod integrator 30, may align the polarization of the light emitted from the rod integrator 30. The liquid crystal element 80 may be arranged at the light emitting side of the DMD 50.

### Third Embodiment

Hereinafter, a third embodiment will be described. Hereinafter, a difference from the second embodiment will be mainly described.

In the second embodiment, the polarizing plate 70 is configured to be moved out of the optical path of the light, which is emitted from the light source 10, up to the position in which the polarizing plate 70 does not overlap the optical path (here, the optical path of the light emitted from the DMD 50) of the light emitted from the light source 10.

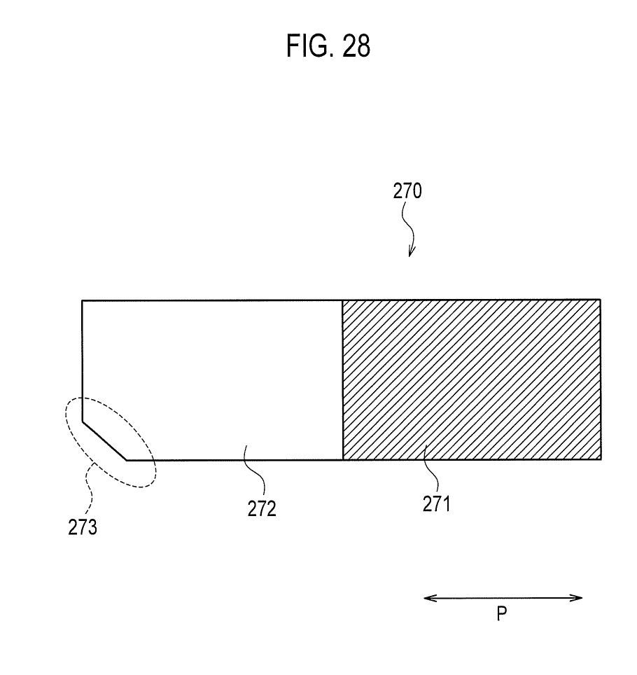

On the other hand, in the third embodiment, as illustrated in FIG. 28, the projection display apparatus 100 includes a plate-like optical element 270 provided with a polarizing region 271 serving as the polarizing plate 70, and a transparent region 272 for adjusting the length of the optical path of the light emitted from the light source 10. The plate-like optical element 270 has a rectangular shape.

Similarly to the polarizing plate 70, the polarizing region 271 is an optical element for aligning the polarization of the light emitted from the light source 10. Specifically, the polarizing region 271 allows only a predetermined polarized light component to pass therethrough.

When the polarizing region 271 has moved to the position not overlapping the optical path of the light emitted from the light source 10, the transparent region 272 absorbs a change in the length of the optical path of the light emitted from the light source 10. The transparent region 272, for example, is formed through the attachment of a transparent resin film.

Specifically, the plate-like optical element 270 is configured to be moved to the position in which the polarizing region 271 does not overlap the optical path of the light emitted from the light source 10. When the plate-like optical element 270 has been moved to the position in which the polarizing region 271 does not overlap the optical path of the light emitted from the light source 10, the transparent region 272 overlaps the optical path of the light emitted from the light source 10. Specifically, the plate-like optical element 270 is configured to slide along the P direction.

In the example illustrated in FIG. 28, the plate-like optical element 270 has a cutout 273 for identifying the direction of the plate-like optical element 270. The cutout 273 may be provided in the transparent region 272 or the polarizing region 271.

In addition, the plate-like optical element 270 may also have a mark for identifying the direction of the plate-like optical element 270. When the plate-like optical element 270 has such a mark, the cutout 273 may not be provided.

### Modification 3-1

Hereinafter, a modification 3-1 of the third embodiment will be described. Hereinafter, a difference from the third embodiment will be mainly described.

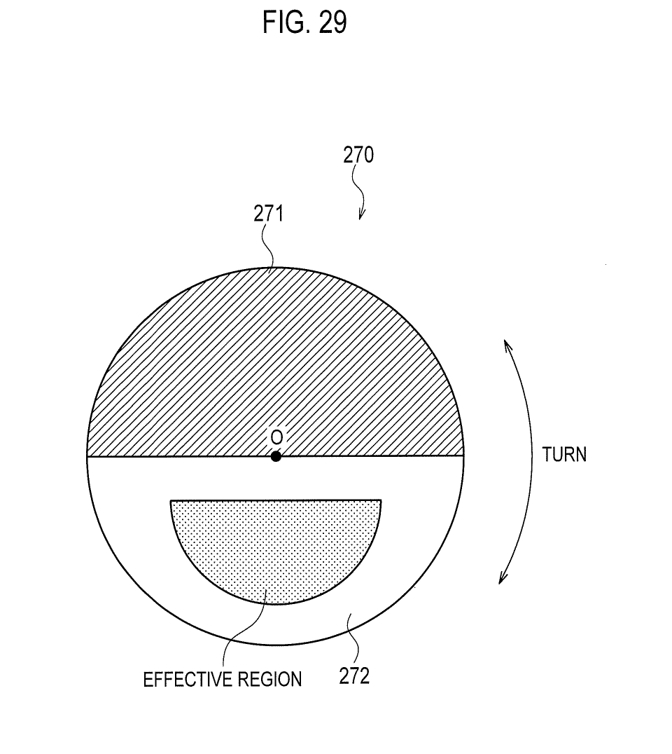

In the third embodiment, the plate-like optical element 270 has a rectangular shape and is slidably configured. On the other hand, in the modification 3-1, as illustrated in FIG. 29, the plate-like optical element 270 has a circular shape and is configured to enable turning. Specifically, the plate-like optical element 270 turns about a point O.

In addition, it is a matter of course that each of the polarizing region 271 and the transparent region 272 has a size capable of covering a range (an effective region) of the optical path of the light emitted from the light source 10.

### Modification 3-2

Hereinafter, the modification 3-2 of the third embodiment will be described. Hereinafter, a difference from the third embodiment will be mainly described.

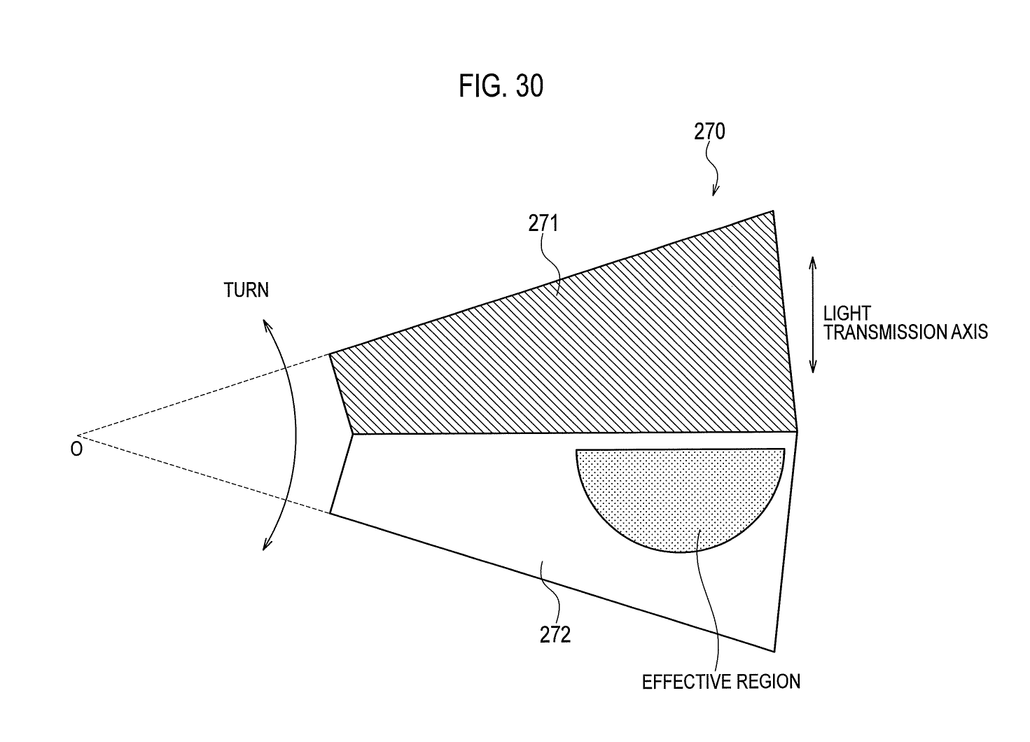

In the third embodiment, the plate-like optical element 270 has a rectangular shape and is slidably configured. On the other hand, in the modification 3-2, as illustrated in FIG. 30, the plate-like optical element 270 has a fan shape and is configured to enable turning. Specifically, the plate-like optical element 270 turns about a point O.

In addition, it is a matter of course that each of the polarizing region 271 and the transparent region 272 has a size capable of covering a range (an effective region) of the optical path of the light emitted from the light source 10.

### Modification 3-3

Hereinafter, the modification 3-3 of the third embodiment will be described. Hereinafter, a difference from the third embodiment will be mainly described.

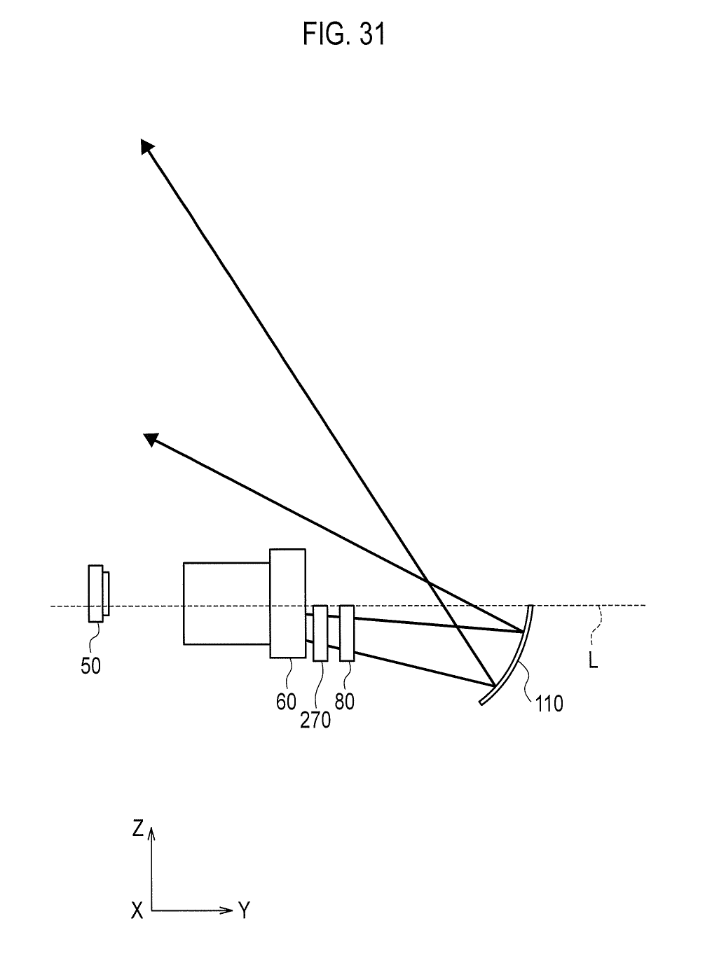

In the modification 3-3, as illustrated in FIG. 31, a description will be provided for the case in which the projection display apparatus 100 is an ultra short focus-type projector. In such a case, the DMD 50 is arranged such that the center of the DMD 50 is provided at a position (here, a position shifted upward from an optical axis L) shifted from the optical axis L of the projection unit 60. Furthermore, the projection display apparatus 100 has a reflection mirror 110 for reflecting the light, which is emitted from the projection unit 60, toward the projection plane. The reflection mirror 110, for example, is an aspherical concave mirror.

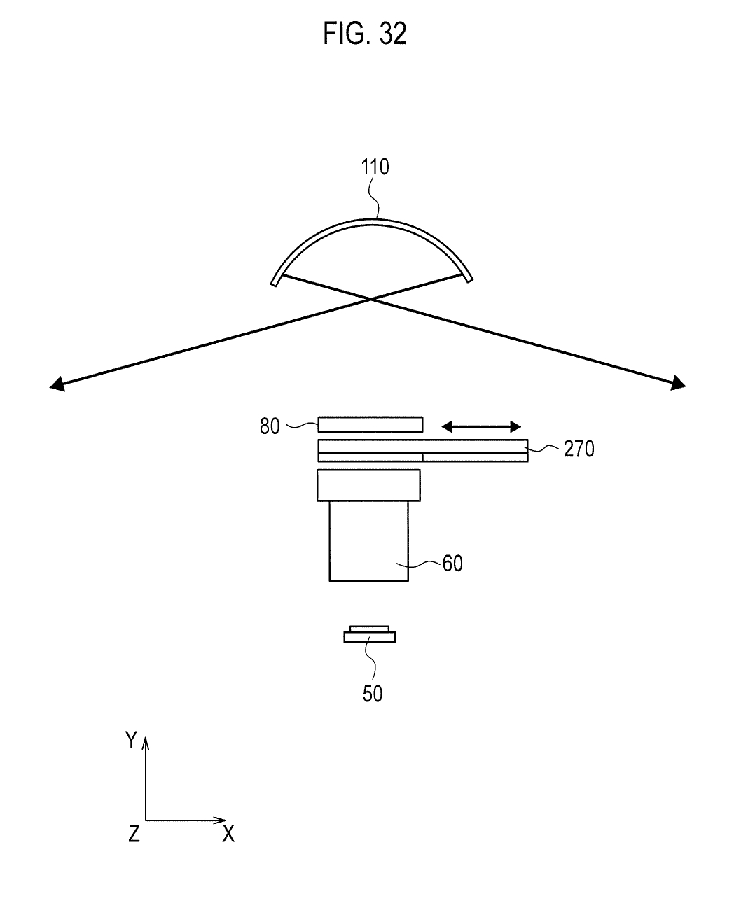

In such a case, as illustrated in FIG. 32, it is preferable that the plate-like optical element 270 is slidably moved along the direction Y, in which the optical axis L of the projection unit 60 extends, and the direction X perpendicular to the shift direction Z of the DMD 50.

### Overview of Fourth Embodiment

A projection display apparatus according to the fourth embodiment has a plurality of 3D modes as 3D modes in which a stereoscopic image is displayed, the plurality of 3D modes including at least a 3D mode of a polarized glasses system using polarized glasses. The projection display apparatus turns on a crosstalk canceller, when the 3D mode of the polarized glasses system is selected.

In the fourth embodiment, the control unit sequentially performs setting guidance processes in a plurality of 3D modes. Accordingly, even when an observer does not recognize a 3D mode in which a stereoscopic image is displayed, it is possible to set a 3D mode, in which a stereoscopic image is displayed, through a simple procedure.

### Fourth Embodiment

Hereinafter, the fourth embodiment will be described. Hereinafter, a difference from the first embodiment and the second embodiment will be mainly described.

In the fourth embodiment, the projection display apparatus 100 has a plurality of 3D modes as a 3D mode in which a stereoscopic image is displayed.

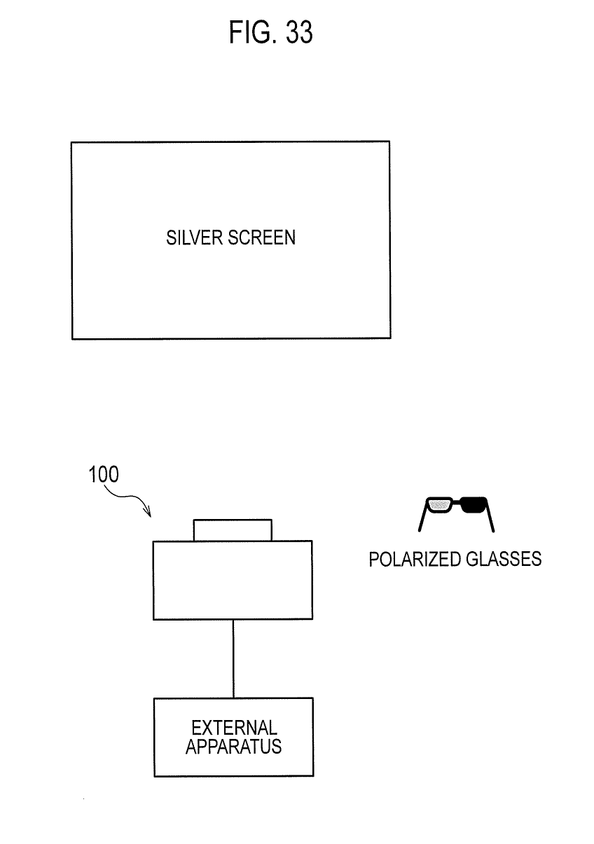

For example, as illustrated in FIG. 33, the 3D mode corresponds to a polarized glasses system using polarized glasses. In the polarized glasses system, a silver screen is used as a screen constituting a projection plane. Furthermore, it is necessary to arrange the polarizing plate 70 at the position overlapping the optical path (here, the optical path of the light emitted from the DMD 50) of the light emitted from the light source 10.

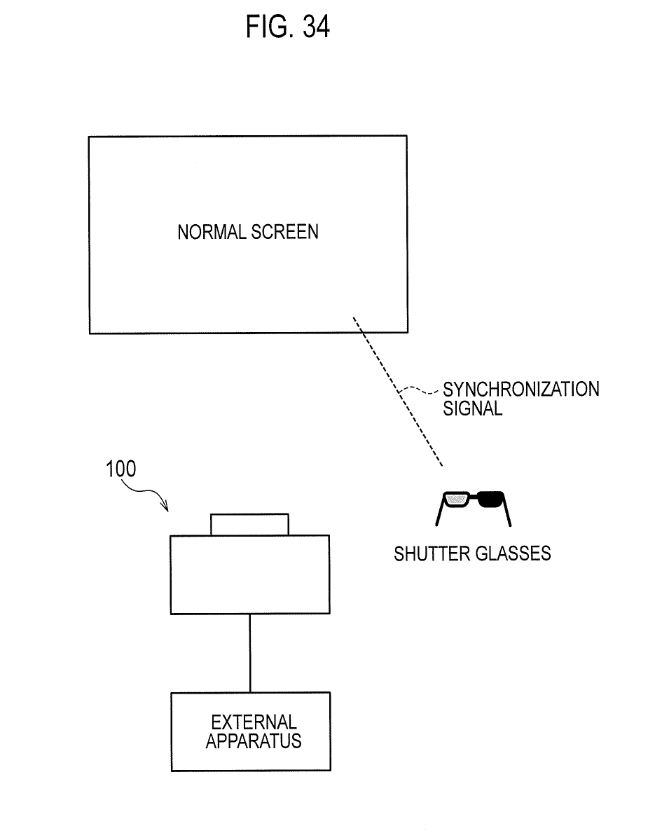

Alternatively, as illustrated in FIG. 34, the 3D mode corresponds to a shutter glasses system (1) for switching the opening and closing of right and left shutters by an image (a synchronization signal) reflected by a screen. In the shutter glasses system (1), a normal screen is used as the screen constituting the projection plane. Furthermore, it is necessary to arrange the polarizing plate 70 at the position not overlapping the optical path (here, the optical path of the light emitted from the DMD 50) of the light emitted from the light source 10. In addition, the image (the synchronization signal) is output from the projection display apparatus 100 in a black display period included in one frame period.

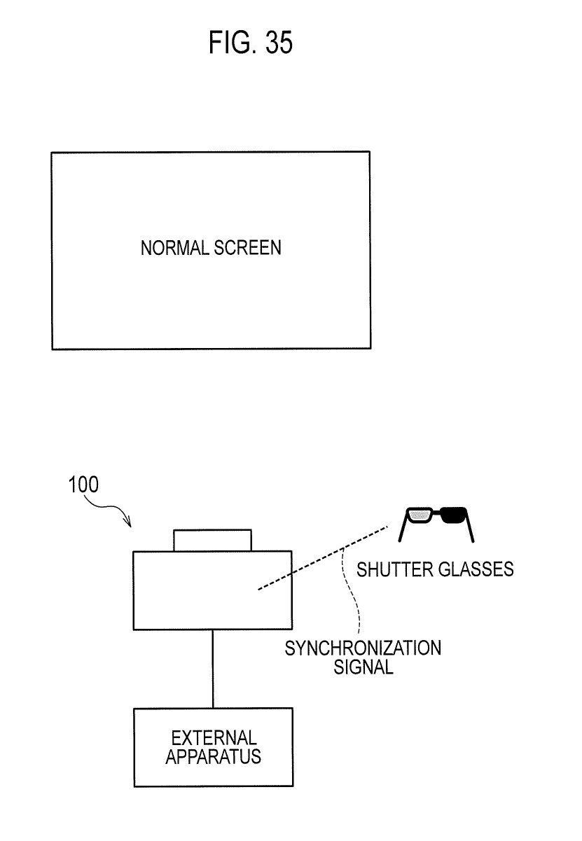

Alternatively, as illustrated in FIG. 35, the 3D mode corresponds to a shutter glasses system (2) for switching the opening and closing of the right and left shutters by a synchronization signal output from the projection display apparatus 100. In the shutter glasses system (2), the normal screen is used as the screen constituting the projection plane. Furthermore, it is necessary to arrange the polarizing plate 70 at the position not overlapping the optical path (here, the optical path of the light emitted from the DMD 50) of the light emitted from the light source 10.

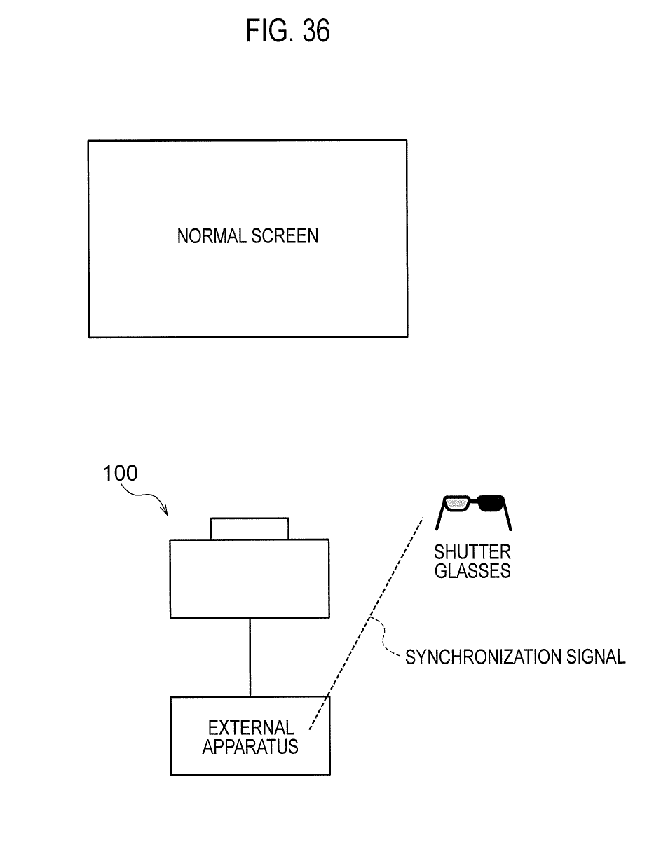

Alternatively, as illustrated in FIG. 36, the 3D mode corresponds to a shutter glasses system (3) for switching the opening and closing of the right and left shutters by a synchronization signal output from an external apparatus connected to the projection display apparatus 100. In the shutter glasses system (3), the normal screen is used as the screen constituting the projection plane. Furthermore, it is necessary to arrange the polarizing plate 70 at the position not overlapping the optical path (here, the optical path of the light emitted from the DMD 50) of the light emitted from the light source 10. In addition, the external apparatus includes a television tuner, a DVD player, a personal computer and the like.

Here, the control unit 200 sequentially performs a setting guidance process corresponding to a 3D mode selected from the plurality of 3D modes. In the setting guidance process, the control unit 200 outputs guidance information indicating a procedure for setting the selected 3D mode, and displays a stereoscopic image according to the selected 3D mode. Here, a description will be provided for the case in which the guidance information is displayed as a guidance image.

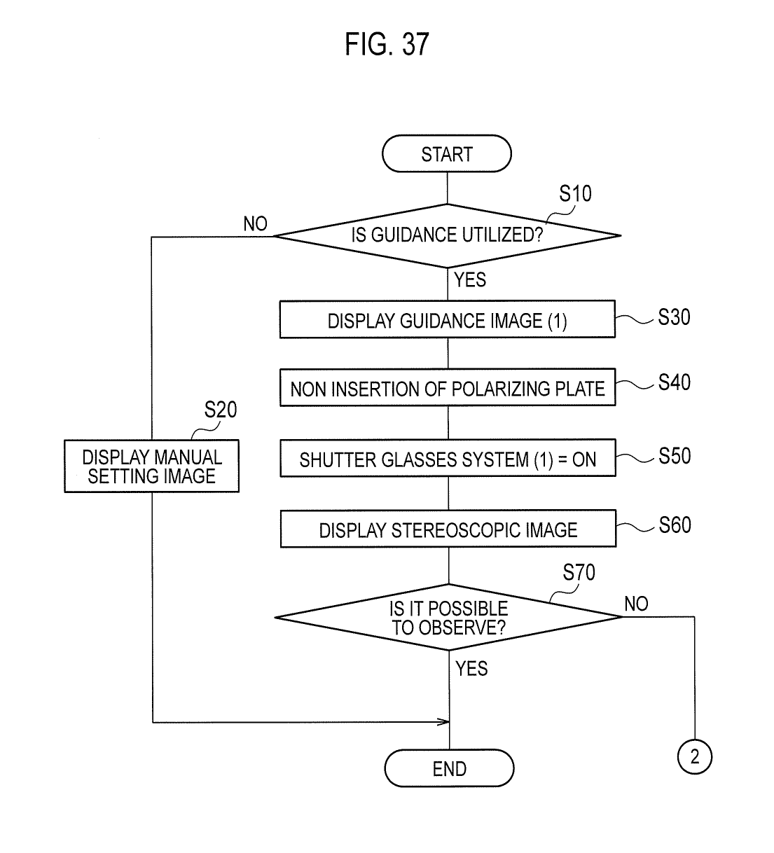

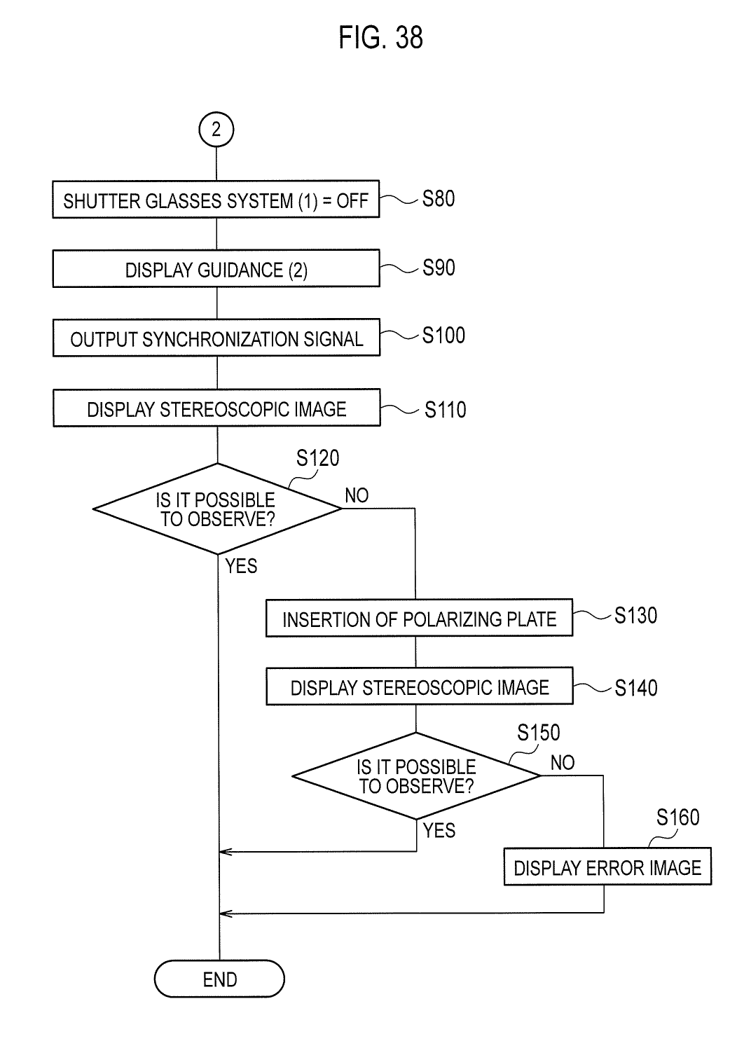

For example, the setting guidance process is performed through the following procedure. FIG. 37 and FIG. 38 are flowcharts illustrating the setting guidance process according to the fourth embodiment. Hereinafter, a description will be provided for the case in which the setting guidance process is performed in sequence of the shutter glasses system (1), the shutter glasses system (2) (or the shutter glasses system (3)), and the polarized glasses system.

As illustrated in FIG. 37, in step 10, an observer determines whether to use guidance. When the determination result is YES, a process of step 30 is performed. When the determination result is NO, a process of step 20 is performed.

In step 20, the projection display apparatus 100 displays a manual setting image for manually setting a 3D mode. Here, the projection display apparatus 100 may display a manual setting image for setting a 3D mode used in image display of a previous time. Alternatively, the projection display apparatus 100 may start an operation in the 3D mode used in the image display of the previous time without displaying the manual setting image.

In step 30, the projection display apparatus 100 displays a guidance image (1). The guidance image (1) includes an image for indicating that cables other than a power cable are disconnected, an image for indicating that the polarizing plate 70 is allowed to move to the position not overlapping the optical path of the light emitted from the light source 10, and the like.

In step 40, the polarizing plate 70 is moved to the position not overlapping the optical path of the light emitted from the light source 10. In addition, the movement of the polarizing plate 70 may be automatically performed by the projection display apparatus 100. Alternatively, the movement of the polarizing plate 70 may be manually performed by the observer.

In step 50, the projection display apparatus 100 turns on the shutter glasses system (1). That is, the projection display apparatus 100 provides a black display period in one frame period, and outputs an image (a synchronization signal) for achieving synchronization with shutter glasses in the black display period.

In step 60, the projection display apparatus 100 displays a stereoscopic image according to the shutter glasses system (1).

Here, it is preferable that the projection display apparatus 100 displays a test image, which is stored in the projection display apparatus 100 in advance, as the stereoscopic image without using a image signal input from the external apparatus. In this way, it is possible to determine a 3D mode to which the projection display apparatus 100 corresponds.

In step 70, the observer determines whether it is possible to observe the stereoscopic image. When the determination result is YES, a series of processes are ended. When the determination result is NO, a process of step 80 is performed.

As illustrated in FIG. 38, in step 80, the projection display apparatus 100 turns off the shutter glasses system (1). That is, the projection display apparatus 100 excludes the black display period from the one frame period.

In step 90, the projection display apparatus 100 displays a guidance image (2). When there exists an emitter for outputting a synchronization signal, the guidance image (2) includes an image indicating that the emitter is connected to the projection display apparatus 100, an image indicating that shutter glasses are powered on, and the like.

In step 100, the synchronization signal is output. When the shutter glasses system (2) is selected, the projection display apparatus 100 outputs the synchronization signal. When the shutter glasses system (3) is selected, the external apparatus outputs the synchronization signal.

In step 110, the projection display apparatus 100 displays the stereoscopic image according to the shutter glasses system (2) (or the shutter glasses system (3)).

Here, it is preferable that the projection display apparatus 100 displays a test image, which is stored in the projection display apparatus 100 in advance, as the stereoscopic image without using a image signal input from the external apparatus.

In step 120, the observer determines whether it is possible to observe the stereoscopic image. When the determination result is YES, a series of processes are ended. When the determination result is NO, a process of step 130 is performed.

In step 130, the polarizing plate 70 is moved to the position overlapping the optical path of the light emitted from the light source 10. In addition, the movement of the polarizing plate 70 may be automatically performed by the projection display apparatus 100. Alternatively, the movement of the polarizing plate 70 may be manually performed by the observer.

In addition, the projection display apparatus 100 may display, as the guidance image, the image for indicating that cables other than the power cable are disconnected, the image for indicating that the polarizing plate 70 is allowed to move to the position overlapping the optical path of the light emitted from the light source 10, and the like.

In step 140, the projection display apparatus 100 displays the stereoscopic image according to the polarized glasses system.

Here, it is preferable that the projection display apparatus 100 displays a test image, which is stored in the projection display apparatus 100 in advance, as the stereoscopic image without using a image signal input from the external apparatus. In step 150, the observer determines whether it is possible to observe the stereoscopic image. When the determination result is YES, a series of processes are ended. When the determination result is NO, a process of step 160 is performed.

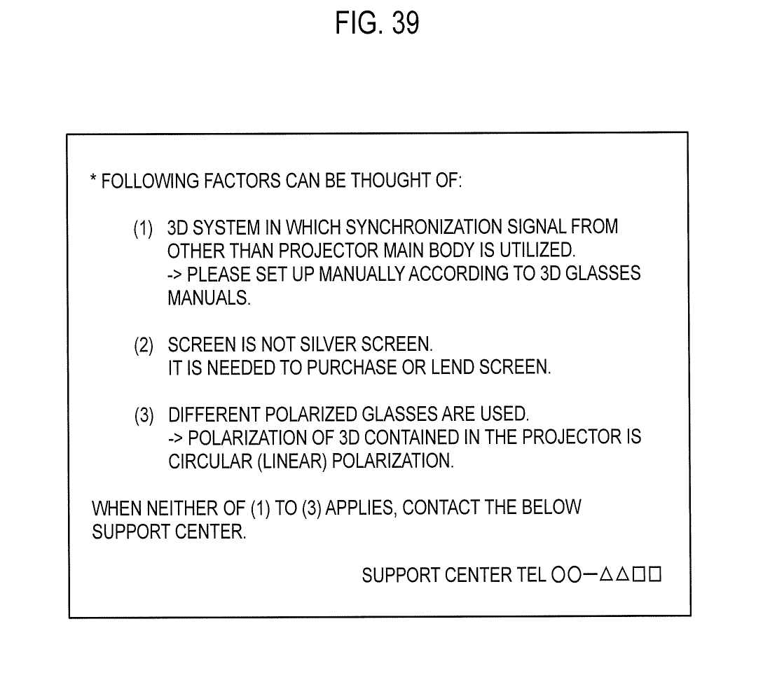

In step 160, the projection display apparatus 100 displays an error image. The error image, for example, is an image for notifying the observer of a factor, by which it is not possible to observe the stereoscopic image, as illustrated in FIG. 39.

### (Operation and Effect)

In the fourth embodiment, the control unit 200 sequentially performs the setting guidance processes in the plurality of 3D modes. Accordingly, even when an observer does not recognize a 3D mode in which a stereoscopic image is displayed, it is possible to set a 3D mode, in which a stereoscopic image is displayed, through a simple procedure.

### Modification 4-1

Hereinafter, a modification 4-1 of the fourth embodiment will be described. Hereinafter, a difference from the fourth embodiment will be mainly described.

In the fourth embodiment, there has been described the case in which an execution order of the setting guidance process is default. On the other hand, in the modification 4-1, the control unit 200 specifies the 3D mode in which the stereoscopic image is displayed, and initially performs a setting guidance process corresponding to the specified 3D mode.

When the silver screen is used as the screen constituting the projection plane, the control unit 200 specifies the polarized glasses system as the 3D mode in which the stereoscopic image is displayed. For example, whether the screen is the silver screen is specified by a screen image captured by an imaging element, and detection of light reflected by the screen.

Alternatively, when the polarizing plate 70 has been arranged at the position overlapping the optical path of the light emitted from the light source 10, the control unit 200 specifies the polarized glasses system as the 3D mode in which the stereoscopic image is displayed. For example, the position of the polarizing plate 70 is detected by a mechanical switch, which is pressed if the polarizing plate 70 is arranged at a predetermined position, and the like.

When the synchronization signal is output from the emitter connected to the projection display apparatus 100, the control unit 200 specifies the shutter glasses system (2) as the 3D mode in which the stereoscopic image is displayed. For example, when the emitter has been electrically or physically connected to the projection display apparatus 100, the control unit 200 specifies the shutter glasses system (2) as the 3D mode in which the stereoscopic image is displayed. For example, whether the synchronization signal is output from the emitter is specified by power supplied from the projection display apparatus 100 to the emitter.

When the synchronization signal output from the external apparatus has been synchronized with image (a frame), the control unit 200 specifies the shutter glasses system (3) as the 3D mode in which the stereoscopic image is displayed. For example, the synchronization signal output from the external apparatus, for example, is detected by a sensor (an infrared sensor and the like).

### Other Embodiments

As described above, the present invention has been described with the embodiments. However, it should be understood that those descriptions and drawings constituting a part of the present disclosure limit the present invention. From this disclosure, a variety of alternate embodiments, examples, and applicable techniques will become apparent to one skilled in the art.

In the embodiments, the description has been provided for the case in which the plurality of viewpoint images constituting the stereoscopic image are the left eye viewpoint image and the right eye viewpoint image. However, the present embodiment is not limited thereto. For example, the plurality of viewpoint images may include three or more viewpoint images.

In the embodiments, the control mode for suppressing crosstalk is switched between the subtraction processing mode and the addition processing mode. The switching timing of the control mode, for example, includes a scene change timing, a change timing of user setting, a timing designated by a user, and the like.

In the embodiments, in the case in which the control mode for suppressing crosstalk is determined, when the amount of crosstalk is subtracted from the image input signal constituting the second viewpoint image, it is determined whether the pixel value becomes less than the lower limit value. In such a case, it may be determined whether the pixel value of a certain pixel of all the pixels becomes less than the lower limit value, or it may be determined whether an average pixel value of all pixels becomes less than the lower limit value.

In the embodiments, there has been described the case in which the amount of crosstalk is changed according to the incident angle of the image light with respect to the projection plane. However, the present embodiment is not limited thereto. Specifically, the amount of crosstalk is changed according to an angle (the direction of the observer with respect to the projection plane) at which the observer observes the projection plane. For example, in a use scene in which the fact that the observers observes the projection plane from an oblique direction with respect to the projection plane has been already known, the image control unit may control the suppression amount of crosstalk according to the angle by which the observer observes the projection plane.

Particularly not mentioned in the embodiments, during the movement of the polarizing plate 70 (or the plate-like optical element 270), it is preferable that the projection display apparatus 100 displays a black image on the projection plane.

In the third embodiment, the projection display apparatus 100 is provided with the plate-like optical element 270 having the transparent region 272 for adjusting the length of the optical path of the light emitted from the light source 10. However, as with the polarizing plate 70 described in the first embodiment, the transparent region 272 may not be provided. In such a case, the length of the optical path of the light emitted from the light source 10 may be adjusted by the shift of the reflection mirror 110. That is, when polarizing plate 70 is moved to the position not overlapping the optical path of the light emitted from the light source 10, the reflection mirror 110 is shifted along the optical path of the light emitted from the light source 10, so that the length of the optical path of the light emitted from the light source 10 is adjusted.

Particularly not mentioned in the embodiments, the control unit 200 may select two or more 3D modes from the plurality of 3D modes, and simultaneously perform setting guidance processes corresponding to the two or more 3D modes.

Particularly not mentioned in the embodiments, the control unit 200 may output the guidance information, which indicates the procedure for setting the selected 3D mode, through sound in the setting guidance process.

In other embodiments, when a 3D mode of the polarized glasses system is selected, the projection display apparatus turns on a crosstalk canceller. In addition, crosstalk cancellation (the subtraction processing mode or the addition processing mode) is performed through the procedure of the above-mentioned first embodiment.

In other embodiments, when a 3D mode other than the polarized glasses system is selected, the projection display apparatus may turn off a crosstalk canceller. Alternately, when a 3D mode other than the polarized glasses system is selected, the projection display apparatus may turn on the subtraction processing mode.

In other embodiments, when the 3D mode of the polarized glasses system is selected, a polarizing plate is inserted into the projection display apparatus to align the polarization of the image light of the stereoscopic image.

In other embodiments, the projection display apparatus switches a 3D mode to the 3D mode of the polarized glasses system according to the insertion of the polarizing plate which aligns the polarization of the image light of the stereoscopic image.

What is claimed is:

1. A projection display apparatus comprising:
a light source,
an imager configured to modulate light emitted from the light source, and
a projection unit configured to project light modulated by the imager onto a projection plane, wherein
the projection display apparatus displays a stereoscopic image including a plurality of viewpoint images,
the projection display apparatus comprising:
an image control unit configured to control a second viewpoint image of the plurality of viewpoint images to suppress crosstalk of a first viewpoint image, wherein
the image control unit controls a suppression amount of crosstalk according to a position on the projection plane.

2. The projection display apparatus according to claim 1, wherein the imager includes a display element including a plurality of micromirrors.

3. The projection display apparatus according to claim 1, wherein the image control unit switches a control mode for suppressing crosstalk between a subtraction processing mode and an addition processing mode according to an image input signal constituting the stereoscopic image.

4. The projection display apparatus according to claim 3, wherein, the image control unit subtracts an amount of crosstalk corresponding to the first viewpoint image from an image input signal constituting the second viewpoint image, in the subtraction processing mode.

5. The projection display apparatus according to claim 3, wherein, the image control unit adds an amount of inverted crosstalk corresponding to an inverted image of the first viewpoint image to an image input signal constituting the second viewpoint image, in the addition processing mode.

6. The projection display apparatus according to claim 4, wherein the image control unit adjusts the image input signal constituting the second viewpoint image to alleviate a change in contrast of an image region, where the contrast suddenly changes, in the first viewpoint image.

7. The projection display apparatus according to claim 5, wherein the image control unit adjusts the image input signal constituting the second viewpoint image to alleviate a change in contrast of an image region, where the contrast suddenly changes, in the inverted image of the first viewpoint image.

8. The projection display apparatus according to claim 6, wherein the image control unit controls a process of alleviating the change in the contrast according to a position in an image.

9. The projection display apparatus according to claim 7, wherein the image control unit controls a process of alleviating the change in the contrast according to a position in an image.

10. The projection display apparatus according to claim 6, wherein the image control unit controls a size or a shape of an alleviation region, where the change in the contrast is to be alleviated, according to a position in an image.

11. The projection display apparatus according to claim 7, wherein the image control unit controls a size or a shape of an alleviation region, where the change in the contrast is to be alleviated, according to a position in an image.

12. The projection display apparatus according to claim 1, comprising:
a polarizing plate configured to align a polarization of the light emitted from the light source; and
a liquid crystal element configured to switch the polarized light of the light emitted from the polarizing plate between a first polarized light and a second polarized light, wherein
the polarizing plate is configured to be moved out of an optical path of the light, which is emitted from the light source, up to a position in which the polarizing plate does not overlap the optical path of the light emitted from the light source.

13. The projection display apparatus according to claim 12, comprising:
a plate-like optical element having a polarizing region serving as the polarizing plate and a transparent region for adjusting a length of the optical path of the light emitted from the light source, wherein
the plate-like optical element is configured to be moved to a position in which the polarizing region does not overlap the optical path of the light emitted from the light source, and
the transparent region overlaps the optical path of the light emitted from the light source, when the plate-like optical element is moved to the position in which the polarizing region does not overlap the optical path of the light emitted from the light source.

14. The projection display apparatus according to claim 1, comprising:
a control unit configured to sequentially perform a setting guidance process corresponding to a 3D mode selected from a plurality of 3D modes provided as 3D modes in which the stereoscopic image is displayed, wherein
the control unit outputs guidance information indicating a procedure for setting the selected 3D mode, and displays the stereoscopic image according to the selected 3D mode, in the setting guidance process.

15. The projection display apparatus according to claim 14, wherein the control unit specifies the 3D mode in which the stereoscopic image is displayed, and initially performs the setting guidance process corresponding to the specified 3D mode.

16. The projection display apparatus according to claim 14, wherein the plurality of 3D modes include two or more 3D modes of a polarized glasses system using polarized glasses, a shutter glasses system (1) for switching opening and closing of right and left shutters by a synchronization signal reflected by a screen, a shutter glasses system (2) for switching the opening and closing of the right and left shutters by a synchronization signal output from the projection display apparatus, and a shutter glasses system (3) for switching the opening and closing of the right and left shutters by a synchronization signal output from an external apparatus connected to the projection display apparatus.

17. A projection display apparatus having a plurality of 3D modes as 3D modes in which a stereoscopic image is displayed, the plurality of 3D modes including at least a 3D mode of a polarized glasses system using polarized glasses, wherein
the projection display apparatus turns on a crosstalk canceller, when the 3D mode of the polarized glasses system is selected.

18. The projection display apparatus according to claim 17, wherein, a polarizing plate configured to align a polarization of image light of the stereoscopic image is inserted, when the 3D mode of the polarized glasses system is selected.

19. The projection display apparatus according to claim 17, wherein the 3D mode is switched to the 3D mode of the polarized glasses system according to insertion of the polarizing plate configured to align the polarization of the image light of the stereoscopic image.
